(19) United States
(12) Patent Application Publication
(10) Pub. No.: US 2016/0135428 A1
(43) Pub. Date: May 19, 2016

(54) SHOWER STALL FOR ANIMALS

(71) Applicant: Michael NICHOLSON, Upper Darby, PA (US)

(72) Inventor: Michael NICHOLSON, Upper Darby, PA (US)

(21) Appl. No.: 14/899,996

(22) PCT Filed: Jun. 23, 2014
(86) PCT No.: PCT/US14/43707

§ 371 Date: Dec. 18, 2015

Related U.S. Application Data
(60) Provisional application No. 61/956,935, filed on Jun. 21, 2013.

(51) Int. Cl. A01K 13/00; F16L 3/02

(52) U.S. Cl. CPC A01K 13/001; A01K 13/003; F16L 3/02

(57) ABSTRACT

A system for washing, dipping, and drying animals includes a water and fume retaining stall, a hood for covering the stall, and an air circulating unit for supplying warm air and for exhausting fumes, including fumes associated with flea and tick formulas used in dipping processes. A double-walled shell coupled with a base unit housing mechanical utilities serves as the stall. Water supply and wastewater drainage systems are coupled for direct communication with a tub, sink or laundry connection, and an associated drain. Fluids can be recycled and discharged to the stall, for reuse, and can be mixed with various solutions, including dipping solutions. The stall, hood and air circulating unit can be modular, for versatility. Steps can be provided to facilitate ingress and egress by the animal. A stool can be provided for the user, and the stall can be elevated, to promote user comfort.

### RELATED CASE

This International application claims the benefit of U.S. Provisional Application No. 61/956,935, filed Jun. 21, 2013, the subject matter of which is incorporated by reference as if fully set forth herein.

### BACKGROUND OF THE INVENTION

The present invention generally relates to an apparatus which can be used to wash or otherwise tend to an animal, and in particular, to a shower stall enclosure for facilitating such activities. While the description which follows will primarily discuss the use of such an apparatus for canines, it is to be understood that the apparatus of the present invention can also be used for other animals as well.

Current pet owners are becoming increasingly attached to their pets, often treating them like members of their family, and are becoming increasingly dedicated in keeping their pets happy, healthy and clean. Pets that live indoors with their owners, as most do, require a higher degree of cleanliness to maintain a clean living environment for all occupants of the home. Skin disease, flea and tick infestations, common pet dander and the shedding of hair are only some of the primary contributors of indoor environmental pollution associated with fur bearing pets. Moreover, many people are allergic to pet dander and veterinarians often recommend bathing dogs at least once a week under such conditions. Fortunately, all of these conditions can be kept under control with proper animal brushing, bathing and dipping on a regular basis.

Most pet owners prefer to accomplish such activities indoors for the convenience of the pet owner and for the comfort of the pet. This often led pet owners bathing or dipping their pets to use available indoor facilities, such as shower stalls and bathtubs, traditionally used by the human occupants of the home. Moreover, there are some bathing and dipping treatments that require the use of pesticides or dirt removal, leading to the potential for contamination of bathing facilities used by people with harmful chemical residues, animal dander, outside contaminants and animal hair that can clog the drains of such facilities.

To avoid the need to use indoor facilities being used by the human occupants of the home, efforts have been made to develop a stall specifically designed for bathing, dipping and drying animals.

For example, “The Canine Shower Stall” offered by Hammacher Schlemmer & Company, Inc., of New York provides an enclosed space for washing and rinsing a dog using a series of water-jet nozzles and an adjustable-flow showerhead. While this apparatus does represent an improvement over prior, more basic versions of a dog shower, it still falls well short of being a complete, indoor, dog washing stall.

A significant drawback is that The Canine Shower Stall uses a 2″ drain pipe for discharging wastewater and other fluids by gravity. This often calls for the discharge of about 30 gallons of soapy water that can be contaminated with pesticides used to kill fleas and ticks. As a consequence, this apparatus is most conveniently used in a garage, or outdoors, in a driveway or patio, so the discharged wastewater can enter a suitable storm drain. This not only tends to limit satisfactory indoor use, but also tends to cause wastewater and the chemicals often used in flea and tick shampoos to enter the storm drainage system, which is environmentally undesirable and potentially deleterious to marine life. Washing a dog in the driveway or on a patio can cause other concerns, such as the need to wash the dog outdoors when the weather may be too cold or too hot, making the process uncomfortable and possibly causing illness for both the owner and the dog.

Moreover, because it is generally preferable to supply warm water for washing, a supply of hot water and a mixing valve are needed, which are usually only found indoors, such as in the laundry room or basement of a house. An extremely long hose is then needed to supply the wash water, making it difficult to use in practice. Also to consider is that while The Canine Shower Stall has casters allowing the apparatus to be wheeled into a garage or shed for storage after use, unless the internal water lines are self-draining, the lines can freeze and burst in colder climates. Cold climates will also limit when the apparatus can be used because of the potential for large amounts of discharged wastewater to freeze, tending to prohibit use during the winter, when the air and the skin are at their driest.

In addition, while multiple water-jet nozzles may help save time, many dogs may likely find this to be an uncomfortable experience, and will resist and become agitated. Also, thorough shampooing requires a proper lather build-up while massaging the skin to remove dead cells, followed by a thorough rinse from the top down. The multiple water-jet nozzles of The Canine Shower Stall do not appear to be particularly well suited to this. A further disadvantage is that, for smaller dogs, the interior of the enclosure requires a stand on which the dog can stand to be in line with the water jets. This, however, will probably tend to jostle a smaller dog, causing further discomfort and distress.

Yet another consideration is that The Canine Shower Stall, and other shower stalls which have been developed, wash the pet in an enclosure which, especially for initial uses, can be a traumatic experience for the pet. Being present and able to give direct, “hands-on” massaging, rinsing, and reassurance can provide comfort and can make the entire process an enjoyable, bonding, experience.

Also to consider is that most common, present-day treatments for flea and tick control for pets are performed by depositing a few drops of a chemical on the skin, at the rear neck area of the pet so the animal cannot lick off the chemical and be poisoned. The applied chemical is absorbed through the skin and into the bloodstream, serving as low-dose chemotherapy. When fleas and ticks bite the animal, the insect will ingest the chemical, which acts as a poison, and die from the toxic chemical within the bloodstream of the pet. While the long-term effects of this are not fully understood, many pet owners prefer using dipping solutions and pesticide shampoos to control fleas and ticks. However, this is made difficult because such processes are usually performed outdoors, with no easy way to retain and recycle the expensive solutions being used. Colder, winter-time temperatures can also limit the time of year when such processes can be done.

It, therefore, remains to develop a shower stall which can be used indoors, which is convenient to use and which is more comfortable and accommodating for the pet. Moreover, it remains desirable to provide an apparatus which can effectively process chemical treatments for flea and tick control.

### SUMMARY OF THE INVENTION

These and other advantages are achieved in accordance with the present invention by providing a dedicated, water-tight, showering stall designed for washing, dipping, and drying animals. The stall incorporates various improvements for ameliorating the problems associated with humans showering fur-bearing animals of all sizes and temperaments within the confines of a home or a business. To allow such processes to be easily performed, and repeated on a regular basis, the stall is configured to provide comfort and convenience to both the pet owner and the pet while a washing or a dipping process is being performed in order to make the overall experience enjoyable.

In a preferred embodiment, such an apparatus is implemented as an enclosed, water and fume retaining stall capable of providing four primary functions used in pet care which can be performed comfortably and efficiently, including clean, warm water rinsing used for washing, the recycling of small amounts of liquid used for dipping, the supply of a warm air-flow used for drying, and exhausting of the fumes commonly associated with the flea and tick formulas used in a dipping process. Such capabilities are preferably provided using separate components which can be added to a fully operational core stall unit to achieve the degree of functionality desired by the user.

The apparatus is preferably implemented using various modular components associated with a core stall unit, including a top hood, a mobile dryer unit, and cooperating elevation stands and staircases. This modular approach is preferred to help meet the various needs and budgets of potential users having different requirements, and pets of all sizes and temperaments. The core stall unit is preferably implemented as an upper, double-walled shell coupled with a lower base unit housing the majority of the mechanical utilities associated with the stall. To satisfy the potentially wide scope of animal sizes, three different sizes of the apparatus are preferably offered so the core stall unit can fit the animal correctly and occupy a minimum amount of space within a home or business.

An automated dipping feature is provided which can recycle a relatively small amount of dipping solution over the animal on a continuous basis to eliminate the internal poisoning process in favor of a significantly simplified dipping process. Flea and tick pesticides can be poured into a small amount of water and recycled within the shower stall to thoroughly mix the solution during the recycling process. When the dipping process is completed, the pesticide solution can be directed into a drain hose, using a valve, and the solution can be combined with fresh water from the unit's rinse nozzle, if desired, to permit the solution to be flushed from the system and into a drain without the need to handle the pesticide solution. Wastewater and any chemicals or other contaminants are preferably discharged from the unit to a sewer system, for example, by placing the discharge of the drain hose in a laundry tub or the like, so any such fluids can be suitably treated before final discharge into the environment.

The circulation of any drained or recycled water is preferably provided using a corrosion-proof pump located under the floor of the stall's enclosure, and advantageously uses a pump that can run dry for up to 8 hours. Offensive fumes, including those associated with flea and tick dipping solutions, can be vented from the enclosure, preferably using a series of four, reverse-flowing, warm-air, drying vents that can be ducted to an outdoor space.

It is not uncommon for the animal to become cold and uncomfortable after washing because the animals's body heat is quickly “wicked” away from their body through their damp body hair. To ameliorate such effects, the animal can be tethered within the shower stall and a warm air circulating unit can be used to supply warm air for heat during washing, and for drying, preferably after a thorough towel drying, through a ventilation system. The ventilation system can be coupled with the enclosure to deliver a quantity of warm dry air, for example, on the order of 530 CFM, preferably through four, adjustable air vents located at each of the four corners within the enclosure of the stall.

Such apparatus can be implemented as a complete line of portable stalls having different sizes, or as a permanent unit having different sizes or a single size, with the addition of elevated stands and staircases, giving the home or business a dedicated animal washing facility with many easy to use functions designed specifically for animal washing, dipping, and drying.

A further description of these and other improvements which can be achieved in accordance with the present invention is provided below, in conjunction with the following drawings.

### BRIEF DESCRIPTION OF THE DRAWINGS

FIG. 1 is a perspective view showing an installation of a system for washing, dipping and drying animals in accordance with the present invention.

FIG. 2 is a perspective view showing one of the hose clamps used for the installation shown in FIG. 1.

FIG. 3 is an enlarged, perspective view showing an adapter for coupling a system for washing, dipping and drying animals with a laundry connection.

FIG. 4 is a perspective view showing the interior of the washing, dipping and drying unit.

FIG. 5 is an enlarged, perspective view of the washing, dipping and drying unit, showing a removable panel for enclosing an end of the unit.

FIG. 6 is a perspective view of the washing, dipping and drying unit, showing a removable panel for enclosing a side wall of the unit.

FIG. 7 is a side elevational view of a hose-line chase for facilitating use of the spray heads.

FIG. 8 is an enlarged, side elevational view of the hose-line chase shown in FIG. 7.

FIG. 9 is a perspective view of a top cap for use with the hose-line chase shown in FIGS. 7 and 8.

FIG. 10 is a perspective view of a clamp assembly for use with the hose-line chase shown in FIGS. 7 and 8.

FIG. 11 is an enlarged, perspective view of the washing, dipping and drying unit, with the drain cover removed to reveal construction detail.

FIG. 12 is a perspective view of a leash holder which can be coupled with the bottom of the enclosure of the washing, dipping and drying unit.

FIG. 13 is a perspective view of the washing, dipping and drying unit, showing stepping areas for accessing and exiting the enclosure of the washing, dipping and drying unit, and also showing a stool for use by a person using the apparatus.

FIG. 14 is a perspective view of the washing, dipping and drying unit, showing a raised platform for elevating the unit and steps for accessing and exiting an elevated enclosure.

FIG. 15 is a perspective view showing an alternative embodiment of the raised platform for elevating the enclosure of the washing, dipping and drying unit.

FIG. 16 is an enlarged, perspective view showing a rim assembly for receiving a curtain for enclosing the bottom of the washing, dipping and drying unit.

FIG. 17 is a perspective view of the washing, dipping and drying unit when configured for storage.

FIG. 18 is a perspective view of an S-hook which can be used for storage of the washing, dipping and drying unit.

FIG. 19 is an enlarged, perspective view of a hood for the washing, dipping and drying unit, with the hood deployed.

FIG. 20 is a perspective view of the washing, dipping and drying unit, showing the hood extending over the enclosure of the unit.

FIG. 21 is a perspective view of the washing, dipping and drying unit, showing the hood in a retracted position.

FIG. 22 is a perspective view of the washing, dipping and drying unit, showing a lighting system for use with the hood.

FIG. 23 is an enlarged, perspective view showing a spray attachment for use with the hood.

FIG. 24 is a perspective view of an air circulation unit for use with the washing, dipping and drying unit.

FIG. 25 is a perspective view showing assembly of the air circulation unit and the washing, dipping and drying unit.

FIG. 26 is an enlarged, perspective view showing a corner piece having an opening for receiving the hoses of the air circulation unit, for use with an alternative embodiment of the washing, dipping and drying unit.

### DETAILED DESCRIPTION OF PREFERRED EMBODIMENTS

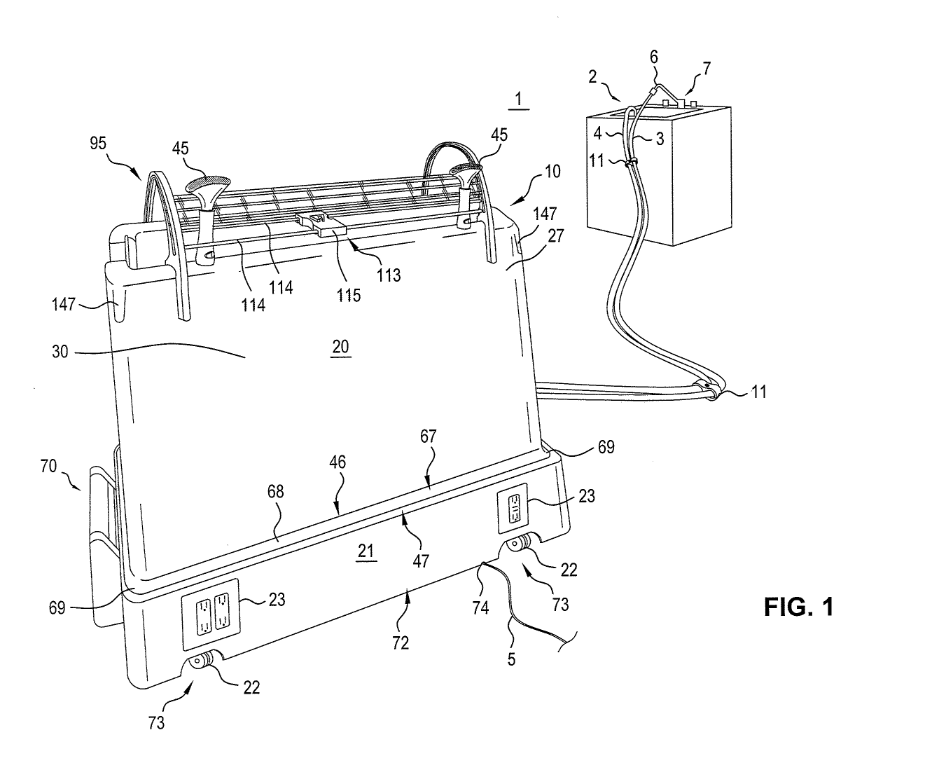

FIG. 1 generally illustrates an installation of a system 1 for washing, dipping and drying animals in accordance with the present invention. The installation illustrated in FIG. 1 is only one example of any of a variety of different installations which can be implemented in accordance with the present invention, and is particularly well suited to use for canines. It is to be understood that other installations and other systems can be implemented in accordance with the present invention, for use with canines, or for use with other animals.

The system 1 generally includes a washing, dipping and drying unit 10 placed in fluid communication with a conventional sink, laundry connection or tub 2 by a pair of hoses 3, 4 and is electrically coupled with a conventional electrical (AC) outlet by a cord 5 to provide power for operation of the unit 10. One of the hoses 3 is used to draw fresh water for the unit 10, for example, from the tap 6 of the spigot 7. The other hose 4 is used to discharge fluids from the unit 10, as will be discussed more fully below, which can empty into the tub 2, the drain of the tub 2, or some other suitably plumbed connection, if desired.

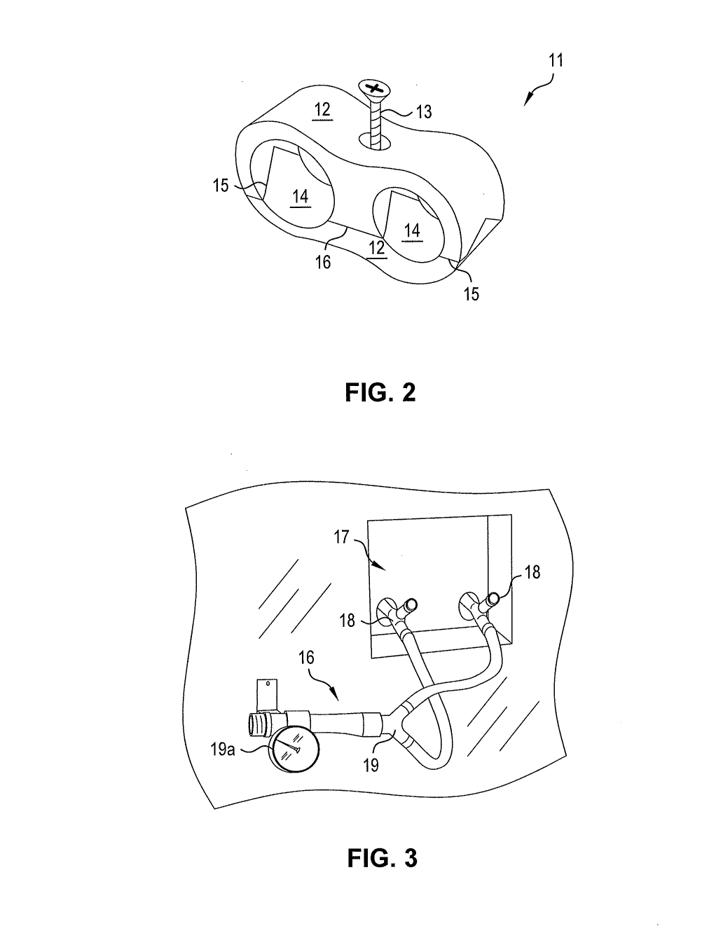

To facilitate set-up and storage of the unit 10, as will be discussed more fully below, the hoses 3, 4 are preferably joined at spaced locations by the clamps 11 shown in FIGS. 1 and 2. Referring to FIG. 2, the clamps 11 include opposing half shells 12 which are connectable using conventional hardware, such as the illustrated screw 13. Each half shell 12 includes recesses 14 which combine to form cavities for receiving the hoses, and cooperating flanges 15, for example, cooperating V-cut surfaces, to facilitate assembly and alignment of the half shells using the hardware 13. The various features of the clamps 11 can be varied, as needed, to suit a particular application.

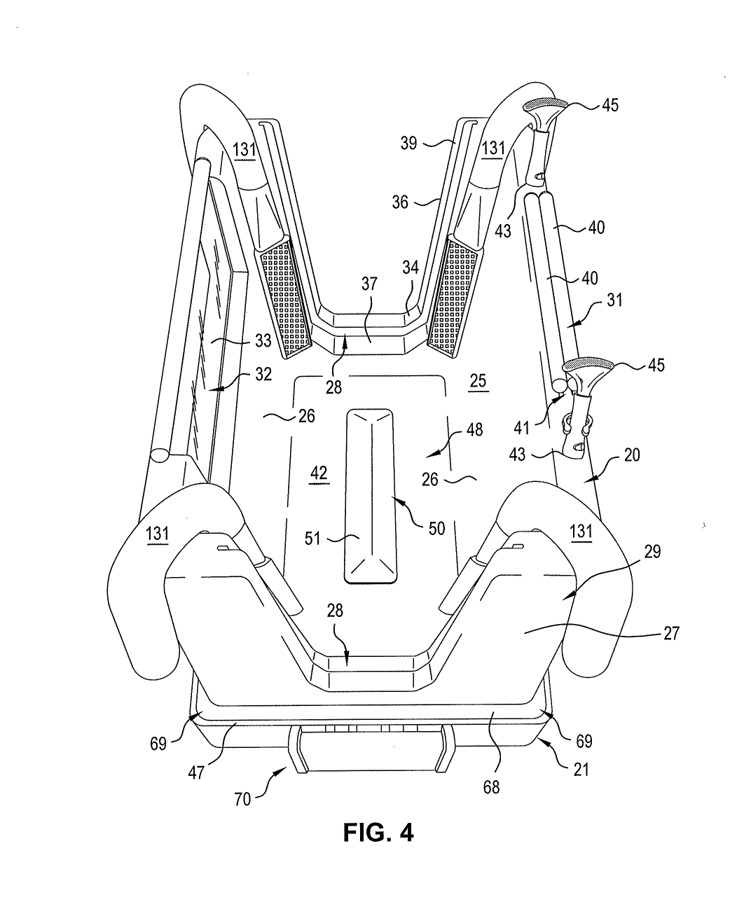

FIG. 3 shows an adapter 16 for coupling the unit 10 with a laundry connection 17. A splitter, such as a Y-valve 18, is preferably coupled with each of the existing “hot” and “cold” mixing valves of the laundry connection 17 to divert water to the system 1 while preserving the connection with the existing washing machine. A coupling 19, such as a Y-coupling, is used to combine hot and cold water from the mixing valves, allowing the temperature of the water to be controlled, and communicates with the hose 3 to deliver water to the unit 10. The coupling 19 can include a temperature gauge, or a separate temperature gauge 19a can be used, if desired.

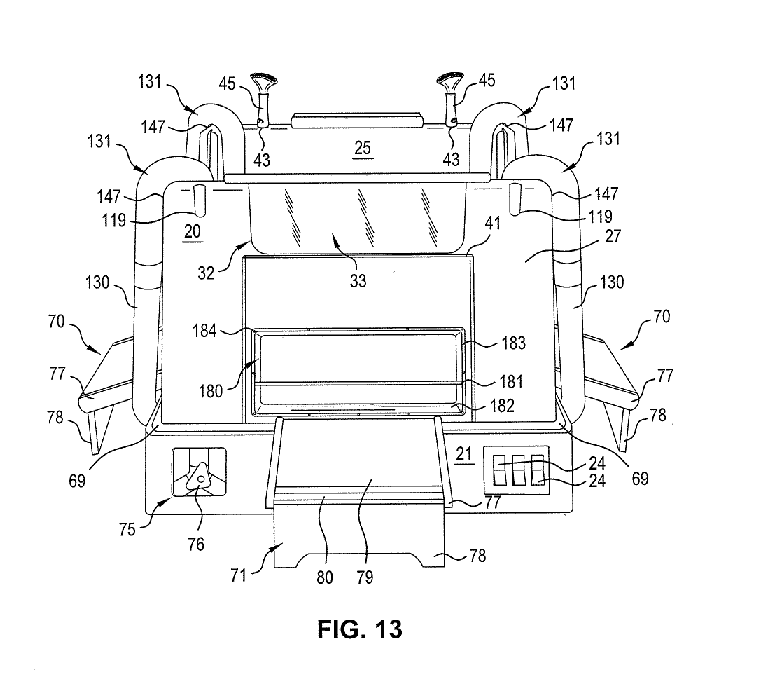

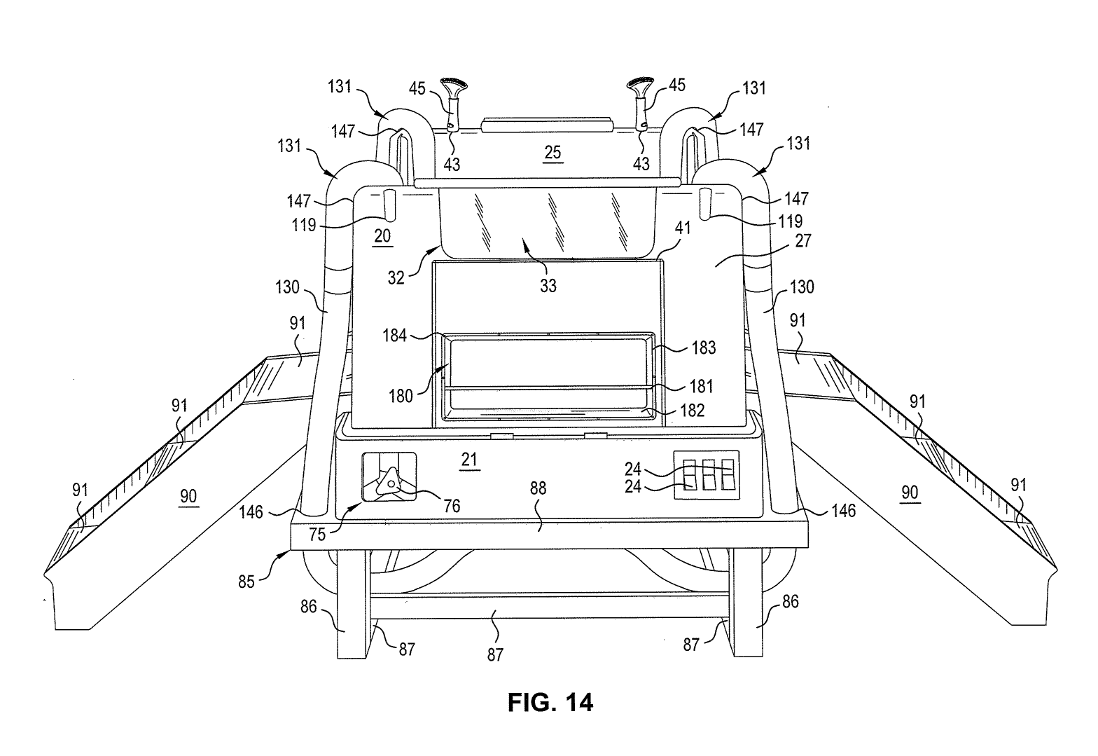

The washing, dipping and drying unit 10 generally includes a shower stall enclosure 20 combined with a base 21 housing various components for operation of the system 1. The base 21 is preferably fitted with casters 22, or other similar rolling structures, to facilitate desired movements of the unit 10. The unit 10 is also preferably provided with one or more electrical outlets 23, as is shown in FIG. 1, and one or more electrical switches 24, as is best shown in FIGS. 13 and 14, to control operations of the unit 10, any ancillary equipment used with the unit 10, and the electrical outlets 23, if desired.

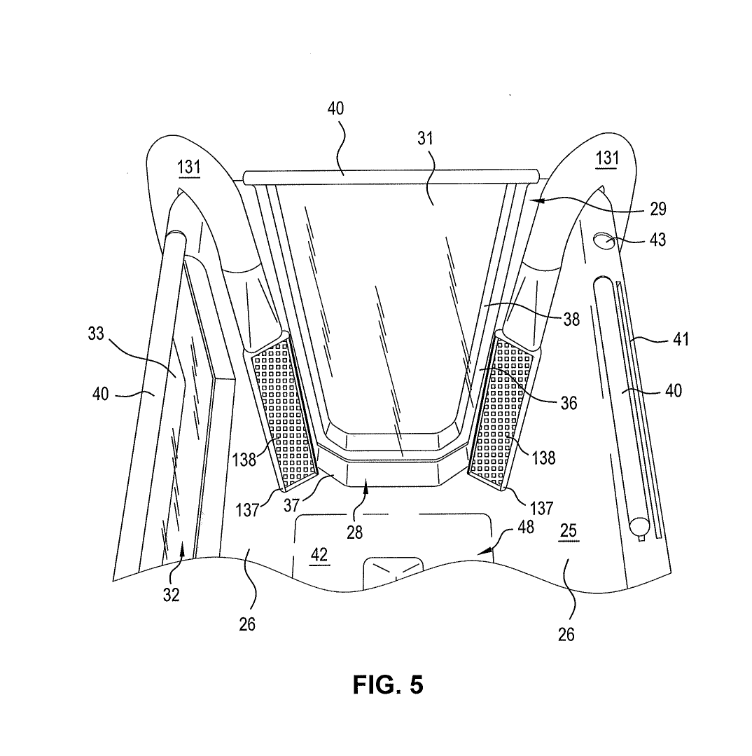

Referring to FIGS. 1 and 4, the enclosure 20 is preferably formed as an upper shell 25 having inner and outer walls 26, 27 separated by a hollow cavity. Top edges of the inner and outer walls 26, 27 are preferably formed by rounded, jointed edges for comfort and convenience. The shell 25 is preferably made of plastic, using molds to achieve the proper shapes and tolerances, although other materials such as wood, wood laminate, fiberglass, or metal could also be used, if desired.

Referring to FIGS. 4 and 5, the shell 25 has two, opposing door openings 28 for entering and exiting the shower stall defined by the shell 25. For ease of use, the openings 28 are preferably located centrally on the shorter sides 29 of the enclosure 20, which form ends of the enclosure 20, and which are joined to the longer sides 30 of the enclosure 20 to form the generally rectangular enclosure illustrated. A removable panel 31 is preferably used to enclose each of the openings 28.

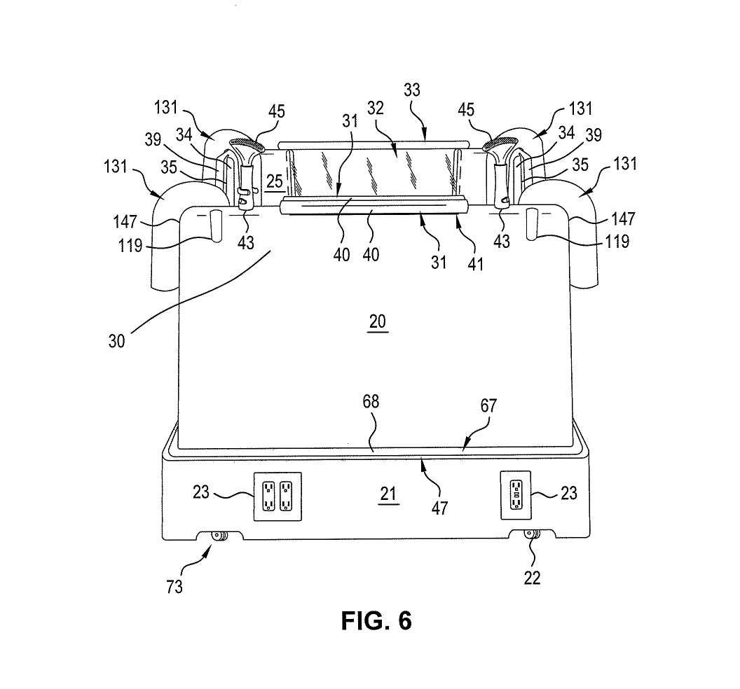

Referring to FIG. 6, the shell 25 also has an opening 32, which is preferably located in upper portions of one of the sides 30 of the enclosure 20, to facilitate access to an animal situated in the enclosure 20 and desired servicing of the animal. For ease of use, the opening 32 is preferably located in the side 30 which forms the front of the enclosure 20. A removable panel 33 is preferably used to enclose the opening 32.

The openings 28, 32 are preferably made waterproof. In the embodiment illustrated, this is accomplished by tapering the openings 28, 32 inwardly so the openings are wider at the top than toward the bottom, and by providing each opening 28, 32 with correspondingly tapered jambs 34, the outer edges of which are preferably aligned with the outer walls of the enclosure 20. The door jambs 34 each preferably include recessed notches or plows 35 located on opposing edges 36, which can act as tracks for the panels 31, 33, and which are preferably slightly wider than the thickness of the panels 31, 33 to facilitate sliding engagement with the plows 35. The resulting tracks established for the entry and exit doors 31 preferably extend about 75% of the way down the entire height of the openings 28. The plows 35 of the access opening 32 preferably extend along the opening 32. As an alternative to openings 28, 32 having tapering U-shapes which are wider at their top, the openings 28, 32 can also have a rectangular shape, if appropriate for a particular application. The openings 28, 32 have a base 37 which is preferably pitched inwardly to direct water into the enclosure 20 and toward the drainage features associated with the enclosure.

The openings 28, 32 are each configured to receive the panels 31, 33, respectively, which have extended edges 38 that are slightly shorter than the depths of the plows 35 extending along the lengths of the jambs 34. An overlapping protrusion 39 is provided adjacent to the plows 35, toward the exterior of the enclosure 20, and extends along the base 37 of each opening. The protrusion 39 preferably overlaps the panels 31, 33 by about 1″ when the panels are put in place. The extended edges 38 on the sides of the panels 31 preferably extend about 85% of the way down the entire height of the openings 28 and are engaged within the plows 35 on both sides of the jambs 34 to secure the panels 31 in place. The access panel 33 has extended edges along the width of the panel 33 for engaging the jamb 34 in the same manner as the panels 31. The panels 31, 33 are each preferably made transparent to allow the pet owner to clearly see the animal, and also to assist in calming the animal by allowing the animal to see through the enclosure 20.

Each of the panels 31, 33 is preferably provided with a transom 40 extending across the top edge of the panel, and which is preferably rounded for comfort and ease of use. The transom 40 preferably extends beyond the jambs 34 by about 0.75″. The transom 40 provides a convenient surface for the user to grasp when installing and removing the panels 31, 33, and provides the panel with a stiffened top edge. The transom 40 also provides a stopping surface for engaging top surfaces of the enclosure 20 to facilitate installation of the panels, and to facilitate storage of the panels in slots 41 formed in the enclosure 20.

For example, and in the embodiment illustrated, slots 41 for receiving the panels 31 are formed in the top edge of the enclosure 20, as is shown in FIG. 6. A slot 41 for receiving the panel 33 is formed in the top edge of an extension area 44 which is centrally located on the side 30 which forms the front of the enclosure 20. The extension area 44 preferably occupies about five-eights of the entire front length of the shell 25 and is preferably molded into the shell 25, slanting outwardly, flush from bottom portions of the side 30 and extending outwardly, preferably by about three-quarter inches toward the top of the extension area 44, in-line with and beneath the access opening 32. Slots 41 for receiving the panels 31, 33 can also be provided in other portions of the unit 10, as desired.

The inside and outside corners and the top rim of the shell 25 are preferably rounded and the vertical surfaces of the shell 25 are preferably tapered to be wider toward the bottom 42 of the enclosure 20. This helps provide the shell 25 with smooth exposed edges, for safety and for user comfort, to facilitate the drainage of fluids, to allow the molded shell to be removed from a mold to facilitate manufacture of the shell 25, and to increase the lateral strength of the shell 25 in all directions. The top edge of the enclosure is also advantageously provide with one or more apertures 43 for receiving one, and preferably two, spray heads 45. In the embodiment illustrated, the spray heads are conveniently positioned adjacent to and on either side of the slots 41 for storing the panels 31.

Apertures which are round, having a diameter on the order of 1⅛″, should satisfactorily receive many commercially available spray heads, and secure the spray heads 45 in an upright position which is easily grasped, while providing access for storage of the hoses associated with the spray heads within the shell 25 of the enclosure 20. The apertures for receiving the spray heads 45 each preferably include features for receiving the spray heads 45 and for facilitating movements of the faucet hose lines contained within the upper portions of the shell 25 of the enclosure 20, to help prevent kinking of the hose lines and to promote the easy withdrawal and insertion of both faucet lines during use. This can include various escutcheons or guides for receiving the spray heads 45 and the associated hose lines, or other similar components, if desired.

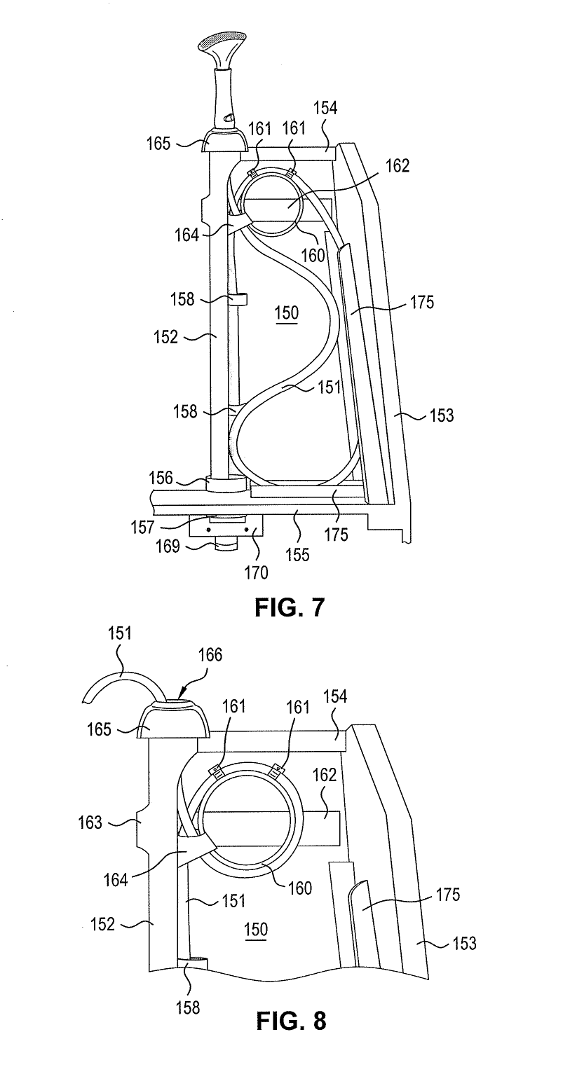

Referring to FIGS. 7 and 8, hose-line chases 150 are preferably used to receive each of the spray heads 45 and to facilitate movements of the associated faucet hose lines. Use of the hose-line chases 150 is preferred to prevent kinking of the hose lines and to allow for easy withdrawal and insertion of the spray heads 45 and the hose lines during use. In the embodiment shown, two hose-line chases are provided, one for each of the spray heads 45. A single hose-line chase 150 could be used for systems 1 having a single spray head 45 and multiple hose-line chases could be used for systems 1 having more than the two spray heads 45 of the illustrated embodiment, as preferred. The hose lines 151 are preferably stainless-steel, mesh-covered faucet hose lines positioned within upper portions of the shell 25 of the enclosure 20. Other types of hose lines can also be used, if preferred. The shell 25 can advantageously be provided with access doors (not shown) for installing, servicing and replacing a hose line 151, as desired.

Each hose-line chase 150 generally includes a riser 152 and a guide 153 retained in spaced relation to each other by an upper support 154 and a lower support 155. The hose-line chase 150 can be formed of discrete components separate from the structural features of the enclosure 20 or can advantageously be formed of components using structural features of the enclosure. For example, the outer surface of the shell 25 can be used to form portions of the guide 153, the top edge of the enclosure 20 can be used to form portions of the upper support 154, and the top surface of the base unit 21 can be used to form portions of the lower support 155.

The riser 152 is advantageously formed using conventional 1½″ PVC plastic pipe, cut to a length about one-half inch shorter than the height of the region which is to receive the assembly. The pipe is vertically sectioned so approximately half of the width of the pipe is removed, except for a 1″ section from either end of the riser 152. The 1″ end section at the bottom of the riser 152 receives a threaded PVC trap adapter 156, for example, a 1½″ to 1¼″ trap adapter, fitted with a plastic nut cemented onto the pipe. The threaded end of the trap adapter is inserted through a hole in the lower support 155, which can be the platform of the base 21, for example, a 1¾″ hole located directly beneath the aperture 43 for receiving the spray head 45. A plastic nut 157 is then applied to the underside of the trap adapter 156 and is tightened to secure the riser 152 in a fixed vertical location. Other materials and other dimensions can be used for the various components previously described, if desired.

The opening in the riser 152 preferably faces outwardly and away from the interior of the shell 25, within an outer corner of the shell 25, to ensure that the coiled hose lines 151 will not enter the storage area provided for the removable panels 31 located in the rear cavity of the shell 25, as previously described. One or more “C” clamps 158, preferably also made of PVC plastic material, are then attached to the riser 152, for example, by glueing, and are preferably sized to flex open and receive the hose line 151 within opened and flared front edges of the clamps 158. The rear portion of the clamp 158 preferably has a curved slot similar to the curvature of the riser 152 for purposes of glueing. In the configuration shown, the clamps 158 are spaced about 5 inches apart. The number of clamps 158 can vary, depending on the height of the riser 152. The clamps 158 operate to restrict movements of the hose line 151 from the base 21, along the exposed edge of the riser 152, to prevent interference with movable sections of the hose line 151.

An anti-kink ring 160 is located above the clamps 158, preferably about 1½″ below the top edge of the shell 25, that operates to prevent the hose line 151 from forming a loop smaller than 2 inches in diameter, which could place a water-restricting “kink” in the hose line 151. The anti-kink ring 160 is advantageously formed using a short length of pipe material, for example, using 2″ to 3″ inch diameter, thin walled PVC pipe having a length on the order of 1¼″, placed near the exit location for the hose line 151 at the top, rear wall of the shell 25.

The ring 160 preferably has two apertures along upper portions of the ring, for receiving an adjustable hose clamp 161. The hose line 151 passes through the clamps 161 and is held in position across the top surface of the ring 160, securing the hose line 151 and preventing the hose line 151 from twisting, which could allow the hose line 151 to leave the riser 152 and travel in uncontrolled directions within the shell 25. Two spaced clamps 161 are presently considered preferred, but can be varied, if desired.

A mounting bar 162 is preferably diametrically connected to the anti-kink ring 160, as a separate component attached to the ring 160 or molded together with the ring 160. As an example, the mounting bar is 1″ wide and also preferably extends about 2″ beyond the ring 160, to within about ⅜″ from the guide 153, which can be the interior wall of the shell 25 or a separate structure. The mounting bar 162 also extends toward the riser 152, preferably about 1″ beyond the opposite side of the ring 160, and terminates in a curved section 163 used to attach the mounting bar 162 and the anti-kink ring 160 to the riser 152. A containment shield 164 also preferably extends between the riser 152 and the anti-kink ring 160 to contain the hose line 151 within a chase defined by the riser 152. The access doors provided for installing, servicing and replacing the hose line 151, as previously described, are preferably located for clear access to the anti-kink rings 160.

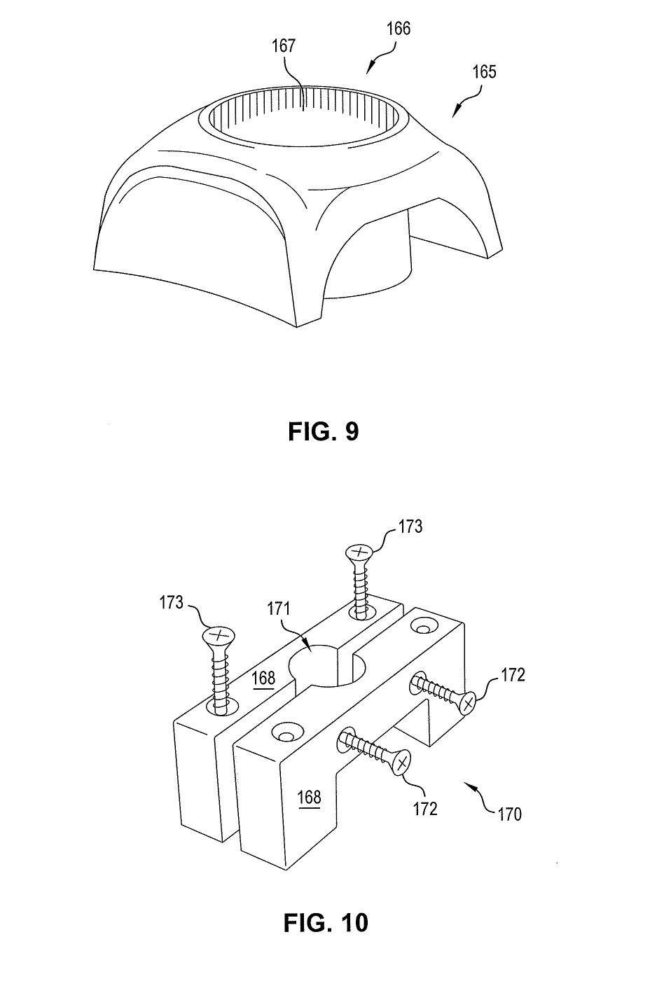

Following installation of an assembled riser 152 within the shell 25 of the enclosure 20, a top cap 165 is inserted through the aperture 43 for receiving one of the spray heads 45 and into the top of the riser 152 forming a chase for the hose line 151. The top cap 165 is preferably formed of a moldable PVC plastic material, and an example of the top cap 165 is shown in FIG. 9.

The top cap 165 secures the upper end of the riser 152 to the shell 25, and preferably includes inner and outer overlapping edges forming an inverted “U” shape for mating with correspondingly shaped upper portions of the exterior surface of the shell 25. Bottom portions of the top cap 165 have an insertion sleeve for engaging upper portions of the riser 152 and for securing the top cap 165 to the upper portions of the riser 152, which can advantageously be formed from a short length of pipe material.

The upper surface of the top cap 165 has a protruding, ring-shaped aperture 166 which is used to support the spray head 45 in an upright storage position, and to provide smooth surfaces for passing a hose line 151 as it moves in and out of the hose-line chase 150. The outer edge of the aperture 166 has an inside curvature followed by an outside curvature that combine to form an inverted “U” shape similar to the rolled upper portions of the shell 25. Inner portions of the top cap 165 have walls 167 which are preferably slightly angled toward the center of the aperture 166, with eased upper edges.

A clamp assembly 170 is used to secure the bottom of the hose line 151 in desired position, and is preferably notched around the retaining nut 157 of the riser 152 so the hose line 151 is spaced from the retaining nut 157. The clamp assembly 170 is located beneath the riser 152, where the hose line 151 exits the riser 152, through the trap adapter 156 and the retaining nut 157, to enter the cavity of the base 21. In this configuration, large offsets are needed to bridge the large plastic nut 157 that secures the trap adapter 156 of the riser 152. The lower portion of the clamp assembly 170 preferably engages the hose line 151 just above the threaded, female turn-sleeve 169. The clamp assembly 170 can be made of wood or plastic materials, as desired.

Referring to FIG. 10, the clamp assembly 170 is preferably evenly split in a longitudinal direction and each half-section 168 preferably includes one-half of an aperture 171 located so that upon assembly, the aperture 171 of the clamp assembly 170 is centrally located, perpendicular to the major axis of the clamp assembly 170, and is slightly smaller in size than the outer diameter of the hose line 151. The two half-sections 168 of the clamp assembly 170 are positioned on either side of the hose line 151 and are tightened using suitable hardware, such as the illustrated screws 172, to draw the two half-sections 168 of the clamp assembly 170 together and to tightly and securely engage the hose line 151. The screws 173 are additionally provided to attach the clamp assembly 170 over the bottom of the riser 152, as previously described, extending perpendicular to the major axis of the clamp assembly. This secures the clamp assembly 170 over the hose line 151 by engaging the bottom surface of the platform forming the base 21, to securely hold the hose line 151 in a vertical orientation, in-line and beneath the hose line chase 150, while also allowing the threaded, female turn-sleeve 169 to engage a suitable hose fitting, which will be described more fully below.

The faucet hose line 151 is accessed from the rear, through an access door suitably located in the shell 25. The hose line 151 is preferably run and adjusted before attaching any clamps that would restrict movements of the hose line 151, such as the hose clamps 161. The hose line 151 is fed through the center hole of the fitting of the trap adapter 156, from the base 21 and into the interior of the shell 25. The hose line 151 is then directed upwardly, passing through the riser 152 of the chase 150 and over the anti-kink ring 160, and then downwardly to the lower support 155, forming a large loop within the interior cavity of the shell 25. Channels 175 can be provided on the guide 153 and the lower support 155, as desired, to help direct movements of the hose line 151 through interior portions of the chase 150. The hose line 151 then proceeds upwardly, through the containment shield 164 and top cap 165, and passes from the aperture 166 of the top cap 165. The hose line 151 can then be gently pulled to remove slack, preferably until the hose line is tightly wrapped around the anti-kink ring 160. The hose clamps 161 are then tightened to secure the hose line 151 in position.

During initial setup, the hose lines 151 are fully extended, and the half-sections 168 of the clamp assemblies 170 are attached, just above the threaded female sleeves 169, by tightening the clamping screws 172. Excess hose line can then be pushed up and into the shell 25, and the screws 173 are then tightened to secure the offset clamp assembly 170 to the underside of the base 21. After the bottom of a hose line 151 has been set, the hose line 151 is passed through the clamps 158 and the containment shield 164, and is drawn over the anti-kink ring 160, preferably while removing slack in the hose line 151. The hose clamps 161 at the top of the anti-kink ring 160 are then tightened, and the hose line 151 is then fed through the remainder of the hose line chase 150, extending from the aperture 166 of the top cap 165. The spray head 45 is then connected to the free end of the hose line 151 and seated in the aperture 166 of the top cap 165.

The lower periphery of the enclosure 20 is provided with an outwardly protruding flange 46 which can advantageously have plural holes or other structures for use in attaching the shell 25 to the top surface 47 of the base 21. The interior surfaces of the enclosure 20 are preferably continuously formed along the bottom 42 and along the inside corners and the other shaped surfaces forming the inner enclosure 20. The floor 48 of the shell 25 preferably has a roughened, non-slip surface for the animal's safety, and includes a drain 50 for the collection and discharge of fluids. The drain 50 is advantageously centrally located along the floor 48, and is preferably rectangular in overall shape. The floor 48 is primarily pitched downwardly, toward the center of the floor 48, and the drain 50. A drain hood 51 extends over the drain 50, and preferably completely covers the drain to prevent the animal from stepping into the drain 50, to protect the animal from harm and to protect the drain 50 from being damaged. The drain hood 51 also preferably has a non-slip surface, similar to the floor 48, and overlaps the floor 48, extending over the recessed drain 50 by about 1″.

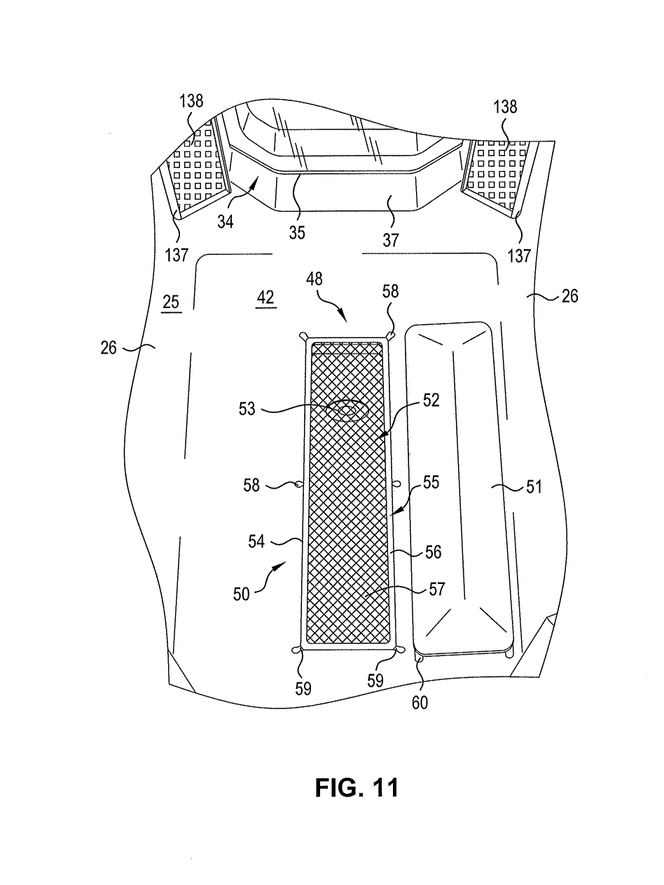

FIG. 11 shows the bottom 42 of the shell 25 with the drain hood 51 removed, exposing the drain 50. The drain 50 is formed as a shaped recess 52 that extends about 1.5″ below the floor 48, and that extends about 75% of the length of the floor and 25% of the width of the floor. The outlet 53 of the drain 50 is preferably offset from the center of the recess 52, in the illustrated embodiment, about three-quarters of the way down the length of the recess 52, toward the access opening 28 which will in use constitute the exit from the enclosure 20. The floor of the remainder of the recessed drain is pitched in the opposite direction, toward the outlet 53, for appropriate flow toward a pump located beneath the floor 48. The edge 54 surrounding the recessed drain 50 is preferably notched or rabbeted to receive a screened, hair trap 55 having a peripheral frame 56 configured to fit within the notched edge 54. The frame 56 of the hair trap 55 is preferably formed as two half sections which can be opened to receive the outer edge of a screen 57, and then closed over the edge of the screen 57 to capture outer edges between the two half sections of the frame 56, preferably using corrosion proof screws to secure the half sections together. As an alternative, the frame 56 can be formed as a unitary structure, for example, by molding the frame 56 over the screen 57. The screen 57 can also include a 1″ recess that acts as a basket to receive and retain loose animal hair, if desired. The screen 57 and the bottom of the recessed drain 50 are preferably separated by about one-half inch so wastewater passing through the screen 57 is free to pass along the floor of the recessed drain 50 to the outlet 53.

A series of recesses 58 preferably surround the frame 56 of the hair trap 55 and the notched edge 54 for receiving the frame 56. Although a series of six recesses 58 have been shown in FIG. 11, any number of recesses 58 can be used, as desired. The recesses 58 can have a diameter on the order of one-quarter inch and preferably include a channel 59 that is pitched toward the drain 50 to direct wastewater collected in the recesses 58 toward the drain 50, for purposes of drainage. The series of recesses 58 also preferably receive a corresponding series of pins 60 depending from the drain hood 51, for covering the recessed drain 50 to prevent injury to an animal standing in the enclosure 20, and while entering and exiting the enclosure, and to protect the screen 57 from damage.

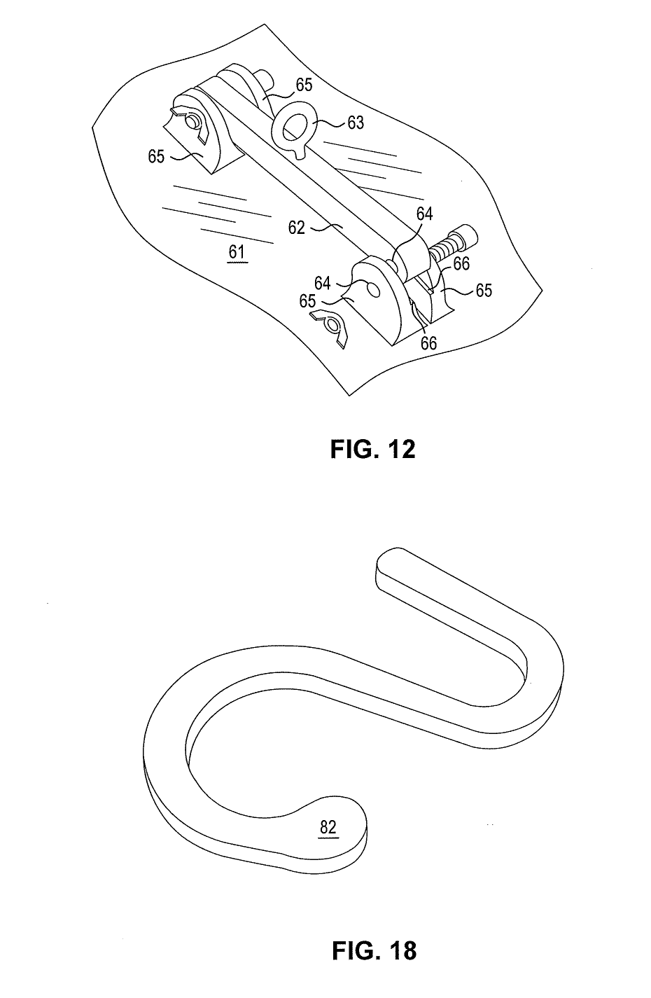

The enclosure 20 is preferably provided with a mounting for receiving a retaining leash for stabilizing an animal located within the enclosure 20. The retaining leash can be joined to a collar worn by the animal, or to a separate harness or muzzle if appropriate. The mounting is preferably provided in the bottom 42 of the enclosure 20, or fixed to the drain hood 51 using, for example, a screw-eye or hook. However, to minimize the potential for harm to an animal within the enclosure 20, the mounting 61 shown in FIG. 12 is preferably used.

The mounting 61 includes a rectangular bar 62 and a mounting ring, such as the illustrated screw-eye 63, attached to the bar 62 for suitably receiving the retaining leash. The bar 62 preferably spans the width of the recessed drain 50, about one-quarter of the way down from the access opening 28 used to exit the enclosure 20, and the mounting ring 63 is preferably centered along the width of the recessed drain 50. The drain hood 51 is provided with a corresponding cut-out area to allow the mounting ring 63 to protrude from the drain hood 51, to receive the retaining leash. The bar 62 further includes through-holes 64 located near opposing ends of the bar 62, for engaging a series of hubs 65 which can be mounted to or molded into the bottom 42 of the shell 25 and which are advantageously located within a 1″ overlap formed by the drain hood 51 to avoid contact with an animal located within the enclosure 20. The hubs 65 are preferably spaced apart, slightly wider than the bar 62, and are provided with corresponding through-holes 64 so opposing pairs of hubs 65 located on either side of the recessed drain 50 can receive opposing ends of the bar 62. Appropriate mounting hardware, such as corrosion proof wing-nuts and bolts, can be inserted in the through-holes 64 of the hubs 65 and the bar 62 to connect the bar 62 to the hubs 65. Either or both pairs of the hubs 65 can include recessed notches 66 to receive and align an end of the bar 62, if desired.

The hair trap 55 is conveniently removed by lifting and removing the screen hood 51, exposing the mounting 61. The wing-nut, or other mounting hardware, is unscrewed and removed from one bolt and the bolt is removed from the hubs 65 to free the bar 62 for rotation away from the hair trap 55, providing clear access to the drain 50. The hair trap 55 can then be removed for cleaning or servicing. The bar 62 can either be left in place during servicing, or removed from the remaining hubs 65, as preferred.

The base unit 21 advantageously houses the utilities for the system 1, and is preferably mated to the shell 25 with minimal effort, such as connection of the drain 50 and attachment of the shell 25 to the base 21. Any trim moldings can be applied when the shell 25 is joined to the base 21, such as the perimeter trim moldings 67 shown in FIG. 1. Referring to FIGS. 4 and 6, inside corner scotia molding is preferably used for the trim moldings 67, and preferably surrounds the entire perimeter of the joint between the shell 25 and the base 21, primarily to cover the outside flange which can be used to receive screw fasteners for attaching the shell 25 to the base 21. The scotia moldings preferably include four bars 68 covering straight lengths of the shell 25, and can be secured in place over the mounting hardware used to secure the shell 25 to the base 21, or to tracks used for similar purposes. Four curved (for example, 90°) outside corner moldings 69 are preferably secured to corners of the shell 25 using mounting clips or hardware passing through apertures which are preferably slightly larger than the attachment hardware being used, to facilitate alignment of the various structures. Surface plugs are preferably used to hide the mountings. Attachment bars or mounting clips used with the scotia moldings preferably have a wide “V” configuration with screw holes that run the entire length of the bars, and the bottom sides of the scotia moldings preferably have a female plow with a similar, wide “V” configuration molded into the bottom surface. Properly sized lengths of the scotia moldings can then be slid into position and held securely by the wider, top surface of the attachment bars. The corner moldings 69, which preferably have the same molded surface details, can be secured in position and joined to the ends of the bars 68, securing the assembly from lateral movement.

The base unit 21 houses the majority of the utilities for operation of the shower stall 25 and, further referring to FIG. 13, also preferably includes opposing fold-in access steps 70 to assist the animal in entering and exiting the enclosure 20 and a stool 71 for use by the operator, for example, to kneel or to use as a step stool. The base 21 is constructed to provide a stable, rigid platform for receiving the enclosure 20. Various materials, which can be the same material or different materials for different components, if preferred, can be used to construct the base 21 and the enclosure 20, including wood, wood laminate, sheet metal, fiberglass, or structural, molded plastic. If needed, additional structural support for the base 21 can be provided using one or more structural members, such as joists or some other suitable internal support. The perimeter of the base 21 preferably has the same tapered, vertical angles and radiuses as the shell 25. Depending on the materials used, the various structures forming the system 1 can be joined with screws, nuts, bolts, adhesives, or some other suitable fastener, coupled with appropriate hinges for the fold-down steps 70 and stool 71. If wood or metals are used, a skin formed of a plastic material can be used to cover exposed surfaces.

Various utilities for operation of the system 1 can be housed within and structurally supported by the base 21. This can include systems for delivering water and other chemicals to the unit 10, and systems controlling fluid flows and electricity for servicing electrical equipment such as one or more pumps, an air drying and ventilating fan, a warm-air heater, lighting, and the previously described electrical outlets 23 and switches 24. If desired, one of the electrical outlets 23 can be used as a “feed outlet” for receiving an extension cord, or the system 1 can be electrically hard-wired from a suitably grounded 120 volt power source. The feed outlet or a hard-wired system preferably includes an otherwise conventional ground-fault interrupt circuit as a safety feature. One of the electrical switches 24 is used to control operation of the pump, which is preferably operated only when water is being circulated. Other electrical switches 24 can be used to control the blower/exhaust fan and the warm-air heater, and one or more of the electrical outlets 23, preferably separately to allow each of the various components to be operated individually. A switched outlet 23 can be used to operate any ancillary equipment associated with the system, such as lighting associated with a hood for covering the shell 25, which will be described more fully below. The electrical switches 24 are preferably located adjacent to the stool 71 to allow convenient access for operation, and can be separate or ganged, as desired.

The lower rim 72 of the base 21 preferably includes one or more cut-outs 73 which can be, for example, 4″ long and 1½″ high, with curved top corners. The cut-outs 73 provide access to locking mechanisms associated with the casters 22. A suitable opening 74, preferably with appropriate strain relief, can be provided for receiving a grounded electrical cord 5. Another cut-out 75 is provided for access to a directional control valve 76 for selectively directing water from the pump located beneath the floor 48 to the discharge hose 4 that communicates with the drain of the tub 2 or a house drain, and a dipping hose that can be used to recycle water into the stall 25. The control valve 76 is preferably a plastic Y-valve, such as the Marelon® Model No. 902007 MF854 valve, manufactured by Forespar® Corporation of Santa Margarita, Calif. A Little Giant® Model No. 578603, H.C. (High Corrosive) series Magnetic Drive Pump, having a flow rate of 500 G.P.H. and manufactured by the Franklin Electric Co. of Bluffton, Ind., is preferably used because the pump is designed to run dry for up to eight hours without harm to the pump.

The pump preferably couples the outlet 53 of the drain 50 with the inlet of the control valve 76. The discharge hose 4 passes through the base 21 and the shell 25, and is preferably coupled with one of the outlets of the control valve 76. The dipping hose passes through the shell 25 to one of the spray heads 45, for example, the left-most spray head 45 relative to the operator's position, and is preferably coupled with another outlet of the control valve 76. The remaining spray head 45, to the right of the operator, is preferably coupled with the hose 3 used to supply fresh water to the unit 10. The spray heads 45 can be reversed in position, if more convenient, and are preferably vertically fed using, for example, a washing machine feed line with a stainless steel mesh covering to help prevent kinking. An operator can then use the appropriate spray head 45 to perform washing while wastewater is directed through the hose 4, or to recycle fluids to perform dipping using the other spray head 45.

The stool 71 is preferably centrally located along the front of the enclosure 20, and is preferably foldable so the stool can be deployed for use by the operator. The stool 71 can be retracted for storage and remain closed and out of the way if the operator prefers to stand. The stool 71 includes a top section 77 and a support section 78. The top section 77 is hinged to both the support section 78 and the base 21 of the enclosure 20 so the stool 71 can be raised into position or folded closed, as needed.

When deployed, the top section 77 of the stool 71 is preferably pitched downwardly toward the operator. The top section 77 preferably establishes a kneeling surface for the user which initially slopes downwardly, from the enclosure 20 toward the user, and then curves or slopes upwardly to develop a raised portion 79, followed by a depending shelf 80. When kneeling on the top section 77, the protruding surface of the raised portion 79 operates to help receive and support the knees of the user to better distribute the weight of the user and to help prevent the user from slipping down the sloping top section 77 when kneeling above the curved area. This helps to prevent knee fatigue when positioned on a deployed stool 71. The top section 77 is also preferably carpeted, for comfort and to help prevent the knees of the user from slipping down the sloping top section 77. The top section 77 can be automatically placed in an appropriate orientation by properly selecting the elevation established by the height of the support section 78.

One of the steps 70 is preferably centrally located along the side of the enclosure 20 that will be used to allow access to the enclosure, and another one of the steps 70 is preferably centrally located along the opposing side of the enclosure 20, for use when exiting the enclosure 20. The steps 70 are each preferably foldable so the steps can be deployed for use or can be retracted and stored, as needed. The steps 70 are similar in configuration to the stool 71, except that the top sections 77 of the steps 70 are preferably flat and do not include a raised portion 79. The top section 77 is also preferably carpeted to provide traction for a pet entering or exiting the enclosure 20.

The stool 71 and the entry and exit steps 70 are preferably joined to the base 21 with conventional pin-type door hinges. The pins of the hinges can then be removed when necessary for removal of the stool and the steps to service the utilities housed in the unit 10. The stool 71 and the steps 70 can also be removed to reduce the overall width of the unit 10 when moving the unit 10 through size-restricted door openings, to gain access to obstructed access openings for servicing equipment located in the base 21 of the unit 10, and to replace the steps 70 with stair case units using correspondingly configured hinge plates, as will be discussed more fully below.

For example, the base 21 can be provided with cut-outs for accessing the pump, a drain valve or other components located under the base 21, and these cut-outs can be obstructed by the stool 71 and the steps 70 when lowered or when deployed. An obstructed cut-out is easily accessed by removing the two hinge pins securing the stool 71 or step 70 to the enclosure 20, and removing the stool 71 or the step 70 to access the pump, for periodic lubrication or servicing, and to access the valve used to drain residual water or wastewater that is back-flushed into the pump from the drain hose 4 or other, internal hoses coupled with the pump after the pump has been turned off. A half gallon, low profile canister can be used for drainage purposes, which can be separate from the base 21, or attachable and removable from the base 21, if preferred.

In some applications, the operator will prefer to use the system 1 while kneeling, or while standing over the animal, with the system 1 configured as previously described. For other applications, the operator may prefer to stand, without the need to bend over. Use while standing can be facilitated by elevating the unit 10. Elevation of the unit 10 on the order of 16″ is presently considered preferred for use while standing, and to convert the movable unit previously described to a fixed unit elevated to a height suitable for most users.

For example, and referring to FIG. 14, the unit 10 can be placed on a raised platform 85 to elevate the unit to a desired height. The height of the unit 10 can be varied, by varying the lengths of the legs 86, or the height can be made adjustable using telescoping, sliding or other heavy-duty mating structures. For added support, angled braces or cross members such as the cross members 87 can also be provided. The edges of the platform 85 preferably include a rim 88 to facilitate alignment of the unit 10 when placed on the platform 85 and to help prevent lateral movement of the unit 10 following placement on the platform 85. The top surface of the platform 85 is also preferably provided with a series of apertures for receiving the casters 22, to allow the wheels of the casters 22 to drop below the surface and to support the rim 72 of the unit 10 on the flat surface of the platform 85, to provide a more secure assembly. The area beneath the platform 85 can be used to receive ancillary equipment, to be described more fully below, or for the storage of supplies to be used with the system 1, such as soaps, chemical treatments, combs, brushes and the like. Structures beneath the platform 85 are preferably spaced inwardly from the rim 88, for example, by about 6″, to provide an open space for foot clearance for the user while standing.

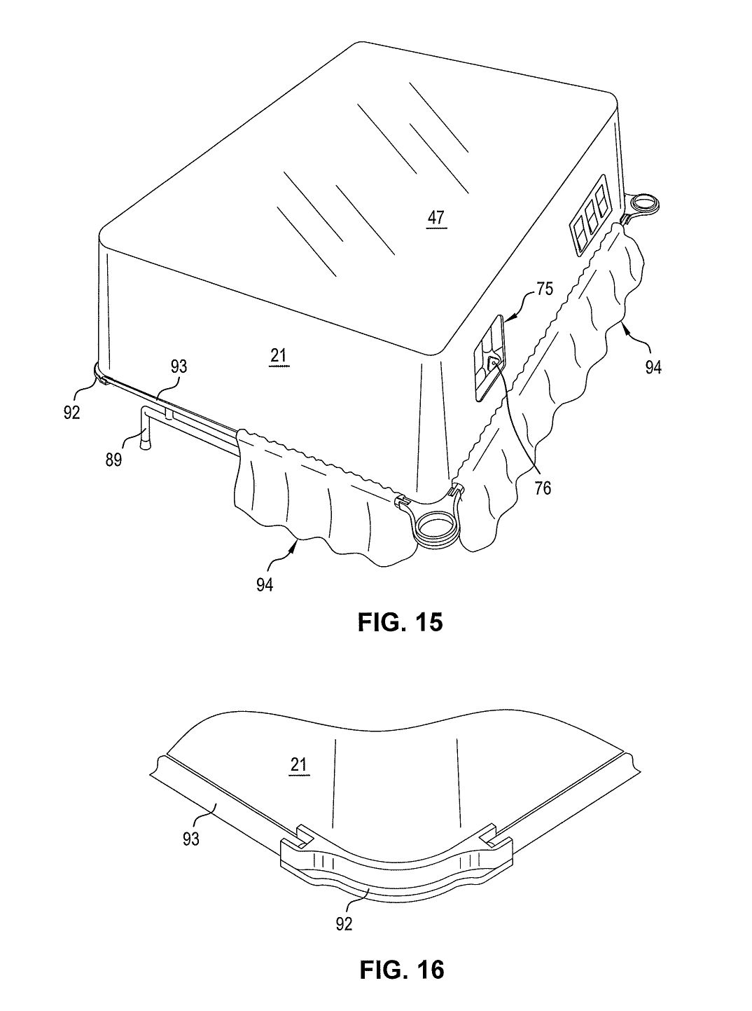

As an alternative, and referring to FIG. 15, the unit 10 can be elevated by providing the underside of the base 21 with suitable structural supports, such as heavy-duty posts or legs 89. The legs or posts can be fixed to the base 21, removably coupled with the base 21, or foldable beneath the base 21, and can be made adjustable in height using telescoping, sliding or other heavy-duty mating structures. For added support, angled braces or cross members can be mated with the legs or posts, similar to the cross members 87 shown in FIG. 14. The area beneath the base 21 of the unit 10 can similarly be used to receive ancillary equipment or for the storage of supplies to be used with the system 1. Structures beneath the base 21 are also preferably spaced inwardly to provide an open space for foot clearance for the user while standing.

To assist the animal in entering and exiting the enclosure 20, the steps 70 can be replaced with two staircases 90, as shown in FIG. 14, by removing the pins retaining the steps 70 to the base 21 and coupling the staircases 90 to the base 21 using the same pins that were used to secure the steps 70 to the base 21. The illustrated staircases 90 have three treads 91, each with a height of about 8.5″, to establish a convenient elevation for entering and exiting the enclosure 20. The treads 91 are also preferably carpeted to provide traction for a pet using the staircases 90. The base 21 of the unit 10 shown in FIG. 15 can similarly be provided with staircases 90 to assist the animal in entering and exiting the enclosure 20, if desired. The treaded staircases 90 can also be replaced with carpeted ramps if desired, for example, to assist older animals that have difficulty climbing and descending steps.

A raised unit 10 can be provided with a curtain or some other covering attached to the base 21 of the unit 10, or to the periphery of the platform 85, if desired, to conceal the legs, posts or supports being used, and any components located beneath the base 21, such as the dryer/exhaust assembly to be described more fully below, to give the system 1 a more finished overall appearance. Referring to FIGS. 15 and 16, the rim 72 of the base 21 includes corner pieces 92, which can be attached to the rim 72 of the base 21 using suitable hardware, and a series of rods 93 seated within and extending between respective corner pieces 92. The curtain 94 can then be suspended from the rods 93, for example, using C-clips, other suitable hardware, or a hemmed chase or loop formed in the curtain.

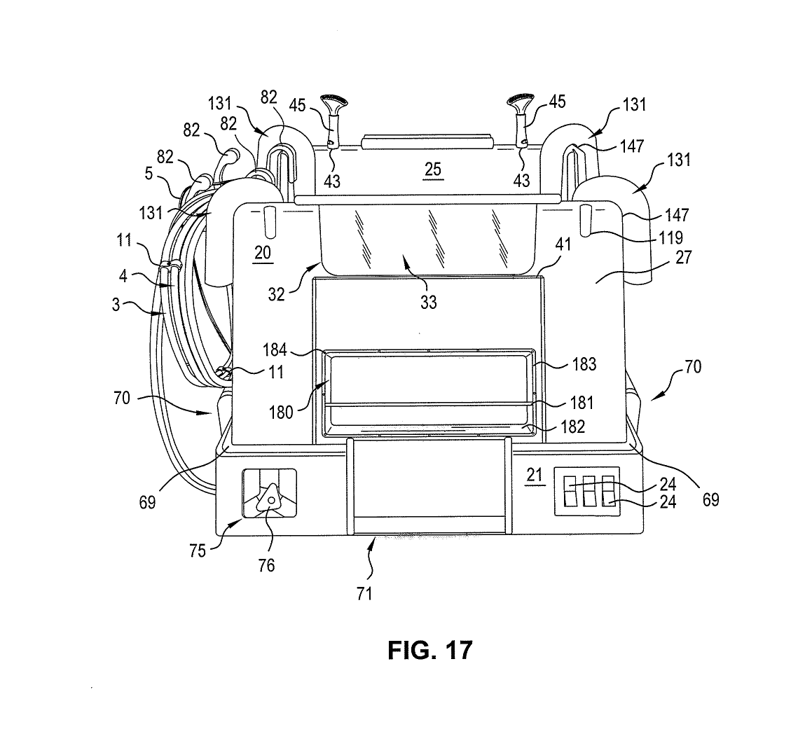

When the system 1 is not in use, primarily for storage, the stool 71 and steps 70 will generally be lowered and stowed away, as shown in FIG. 17, and the casters 22 supporting the base 21 of the unit 10 will generally be free to roll along a floor or other supporting surface, and to pivot, to allow the system 1 to be easily moved. Two of the casters 22, for example, the casters 22 to the rear of the enclosure 20, preferably have a locking mechanism to prevent movement of the unit 10 while in storage, or when in use.

When the system 1 is to be used, the unit 10 can be moved into desired position and connected for operation. The supply hose 3 and the discharge hose 4 extend from the base 21, through an appropriate cut-out or opening. The supply hose 3 is connected to the tap 6 of the spigot 7, or to the mixing valves of the laundry connection 17, as previously described, to draw fresh water for the unit 10, and the discharge hose 4 is coupled with a suitable tub, sink or drain, as previously described, to discharge wastewater. The end of the drain hose 4 can be provided with an inverted, U-shaped hose termination of the type used for washing machine drain hoses to help retain the drain hose 4 in position. The electric cord 5 is plugged into a conventional electrical (AC) outlet to provide power for operation of the unit 10. The stool 70 or the steps 71 can be deployed, as needed, by rotating the top section 77 upwardly from the base 21 and raising the top section 77, and by rotating the support section 78 downwardly and away from the top section 77 to make contact with the floor or other supporting surface.

The opposing end of the supply hose 3 is attached to one of the two outflow connections of a Y-valve, such as a Gilmour 13, Brass, 2-Way Connector manufactured by Robert Bosch Tool Corp. of Peoria, Ill. The remaining legs of the Y-valve can be valved so the user can select between two modes of operation, in this case, to start and stop the water supply. An open leg of the Y-valve, which does not communicate with the remainder of the unit 10, can be used to receive water from the tap 6 of the spigot 7, or the mixing valves of the laundry connection 17, until the water has been brought to a comfortable temperature using the mixing valve of the spigot 7 or the mixing valves of the laundry connection 17. The opened leg of the Y-valve is then closed and the opposing leg is opened, delivering water at the adjusted temperature to the feed hose servicing the unit 10. As an alternative, the Y-valve can be configured to deliver water to the feed hose servicing the unit 10, which can then be sprayed into the shell 25 from the appropriate spray head 45 until the desired temperature is reached. In such case, the pump can be activated using the appropriate electrical switch 24 and the directional control valve 76 can be set to draw water from the drain 50, for discharge through the hose 4 and to the drain of the tub 2 or the laundry connection 17, as needed. The supply hose 3 and the discharge hose 4 preferably have a diameter of ⅝″ and are both preferably of a non-kink variety. The supply hose 3 and discharge hose 4 are preferably joined at spaced locations using the clamps 11 shown in FIGS. 1 and 2 to keep the two hoses neatly attached to each other along their length.

An animal can then enter or be led into the enclosure 20, entering the access opening 28 farthest from the drain 50 and the mounting 61 for receiving a retaining leash, if used. The steps 70 and the staircases 90 can be used to assist in this process. The animal can be stationed in the enclosure 20 by connecting the retaining leash between the mounting 61 and a collar worn by the animal, if desired. The removable panels 31 are then used to enclose each of the openings 28, entering the plows 35 to develop an appropriate, preferably water-tight seal. The removable panel 33 can similarly be used to enclose the opening 32 located in the side 30 of the enclosure 20, or the opening 32 can remain exposed, as preferred.

Washing can then take place using the appropriate spray head 45. For systems which have been pressurized, for example, using the spigot 7 as previously described, washing can take place by opening a valve located on the handle of the spray head 45 to a desired flow setting. For systems which have not been pressurized, washing can take place by opening the leg of the Y-valve that delivers water to the feed hose servicing the unit 10 and by activating the pump using the appropriate electrical switch 24. Fresh water from the Y-valve is then delivered to the spray head 45, for use in washing the animal. The directional control valve 76 can be used to selectively direct water from the pump either to the discharge hose 4, for directing wastewater to the drain of the tub 2 or the laundry connection 17, or to the dipping hose and the associated spray head 45, for recycling the water, primarily for use in a dipping process. Dispensers for washing and dipping solutions can be coupled with the lines associated with either or both of the spray heads 45, if desired, to mix such solutions with water circulating within the lines and to dispense the appropriate mixtures from the spray heads 45. The user can perform such washing and dipping while standing, or the stool 71 can be deployed so the user can kneel while washing or dipping the animal, as preferred.

Upon the completion of a washing or dipping procedure, the panels 31 are removed from the opening 28 used to exit the enclosure 20 and from the opening 28 used to enter the enclosure 20, if desired, and the retaining leash is removed, if used. The panels 31 can then be set aside or stored in the slots 41 formed in the enclosure 20, as preferred. The animal can then exit or be led from the enclosure 20, leaving through one of the access openings 28, normally the opening 28 in front of the animal. The steps 70 and the staircases 90 can again be used to assist in this process. The system 1 is then ready to similarly receive another animal, if desired. In such case, the enclosure 20 can be cleaned using any desired solutions and fresh water from the appropriate spray head 45.

Following use, and preferably after being cleaned, the unit 10 can be left assembled for future use, or can be readied for storage. To ready the unit 10 for storage, wastewater is drawn from the drain 50 and discharged through the hose 4 and to the drain of the tub 2 or the laundry connection 17, preferably until the pump runs dry. The pump is then deactivated. Any remaining wastewater, for example, wastewater remaining in the lines and hoses, can then be manually drained, as needed, through an open leg of the Y-valve, through a purge valve associated with the pump located under the base 21, or by disconnecting the supply hose 3 and the discharge hose 4 from the service location and manually back-draining the hoses 3, 4 into a bucket or floor drain. For example, a ¼″ drain line can be run from the impeller chamber of the pump to a lower valve which empties into a low profile drain tub when winding the hoses up for storage. The drain for remaining wastewater is preferably located at the lowest point available, to facilitate drainage. The supply hose 3 and the discharge hose 4 can then be disconnected from the tap 6 of the spigot 7 or from the laundry connection 17, and from the drain, and the electric cord 5 can be unplugged.

The hoses 3, 4 and the electric cord 5 are then preferably coiled for storage with the unit 10, for example, by placing them in or draping them over the shell 25. As an alternative, the S-hooks 82 shown in FIG. 18 can be used to hang the hoses 3, 4 and the electric cord 5 from the enclosure 20, for example, as is shown in FIG. 17. The panels 31, 33 can either be stored in the slots 41 or returned to the openings 28, 32 for storage. At some point during this procedure, the locking mechanisms associated with the casters 22 are released and the steps 70 and the stool 71 can either be folded to the retracted positions shown in FIG. 17, or removed from the unit 10, as desired. The unit 10 is then ready to be moved, which is facilitated by the casters 22.

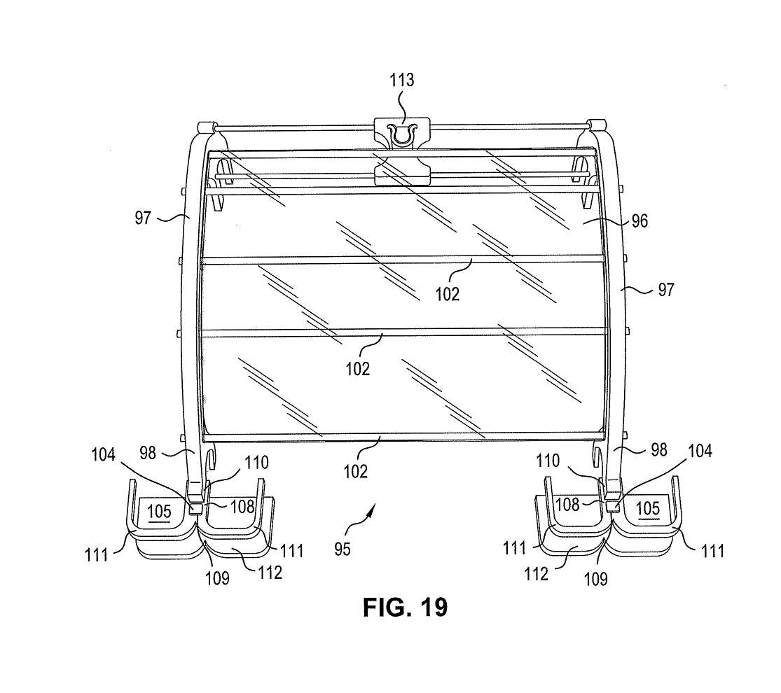

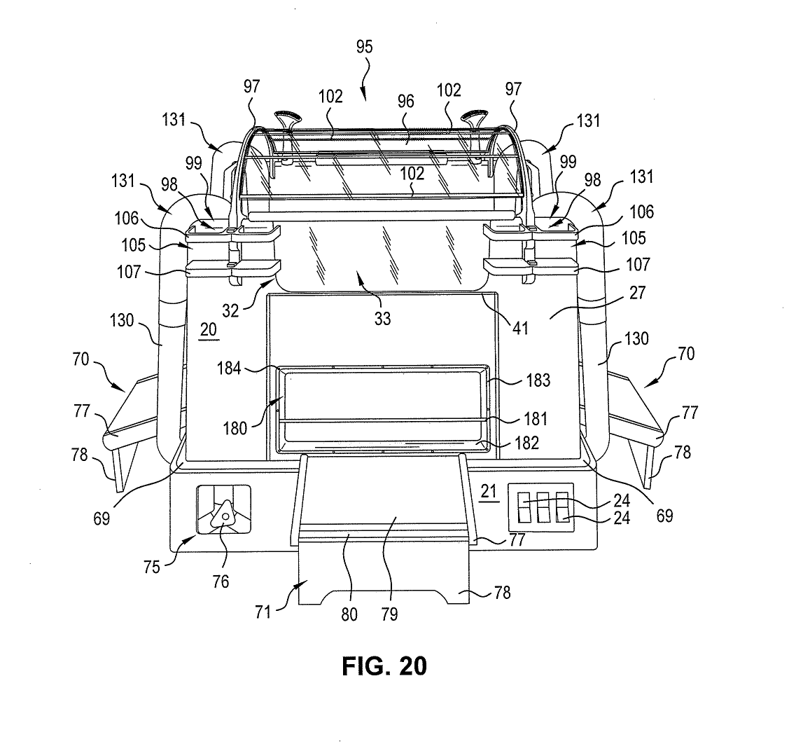

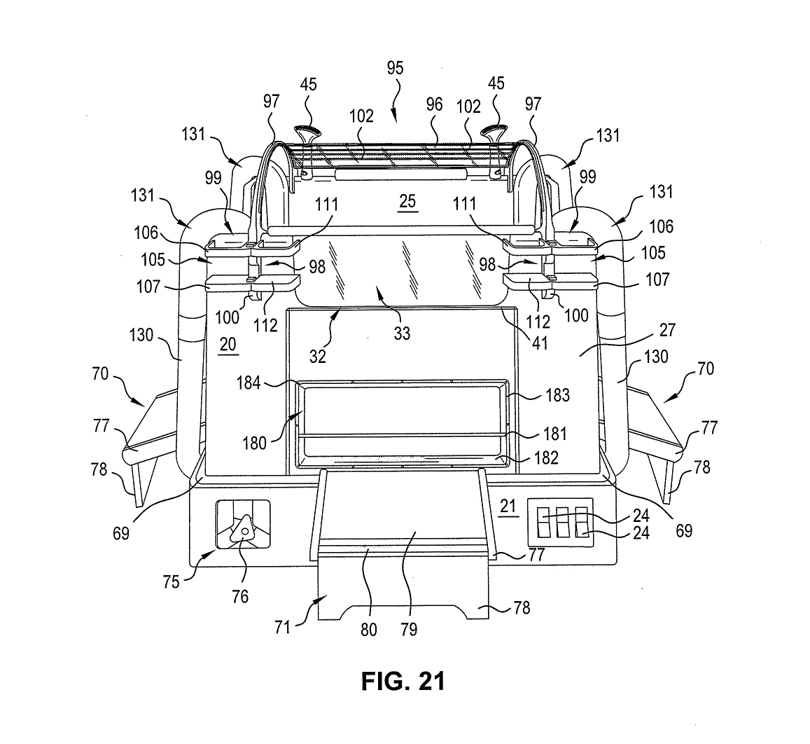

FIG. 19 shows a hood assembly 95 that can be combined with the unit 10 to cover upper regions of the enclosure 20. Use of the hood assembly 95 is optional, although preferred for most applications to help prevent water and any chemicals from being sprayed or splashed from the enclosure 20. FIG. 20 shows the hood assembly 95 with the hood 96 extending over the enclosure 20 and FIG. 21 shows the hood assembly 95 with the hood 96 in a retracted position.

The illustrated hood assembly 95 includes two, arched, truss arms 97, which preferably span the shorter, width of the enclosure 20 and four, inverted, U-shaped brackets 98 located at opposing ends of the two truss arms 97. While this embodiment is presently considered preferred, it will be understood that other configurations having other numbers of truss arms 97 and mounting brackets 98 can be used, having the configuration shown or other configurations, to suit a particular application.

The hood assembly 95 preferably mates directly with the shell 25 of the enclosure 20, without the need for additional attachment hardware, for easy installation and removal. For example, in the embodiment illustrated, the inverted U-shaped recesses of the brackets 98 are sized and shaped to engage the top rim 99 of the shell 25 of the enclosure 20. A close, sliding engagement can be used for this, or inner and outer walls of the top rim 99 of the shell 25 can be provided with recesses, grooves or other aligning structures, such as the illustrated slots 119, to receive the brackets 98 and to position and restrict lateral movements of the hood assembly 95 on the enclosure 20.

Inside edges of the brackets 98 are preferably shaped to mate with the top rim 99 of the shell 25, including any aligning features provided. For example, in the embodiment illustrated, the inside edges of the brackets 98 are rounded and outwardly tapered to mate with the rounded top rim 99 and the outwardly tapering vertical surfaces of the shell 25, and the legs 100 of the brackets 98 are spaced at a distance slightly smaller than structures of the shell 25 to be engaged by the brackets 98 to provide a tight, frictional fit between the joined structures. For secure engagement, the legs 100 are also preferably able to flex by a small amount to apply constant pressure on receiving portions of the shell 25.

Each truss arm 97 includes a plow 101 running along the length of the truss arm. The plows 101 are preferably centered within the truss arm, and extend over the majority of the enclosure 20. A series of rods 102, preferably made from a fiberglass material, extend between the opposing truss arms 97 and through the plows 101 of the truss arms 97. The ends of the rods 102 are preferably retained in position using, for example, locking caps or axle nuts, to minimize lateral movements of the rods 102. A sheet of clear, flexible, plastic material is then placed over and supported by the rods 102, forming the hood 96. The sheet material forming the hood 96 can be double notched at desired intervals, if desired, so the rods 102 can receive portions of the curtain to facilitate movements of the hood 96 along the truss arms 97. As an alternative, the open plows 101 can be replaced by notches or grooves formed in the sides of the truss arms 97, sized to slidingly receive ends of the rods 102. The illustrative embodiment shown includes a series of six rods 102 supporting a transparent hood 96. Other numbers of rods 102 can be provided, and other types of materials can be used for the hood 96, including translucent or opaque sheets and fabrics, if desired.

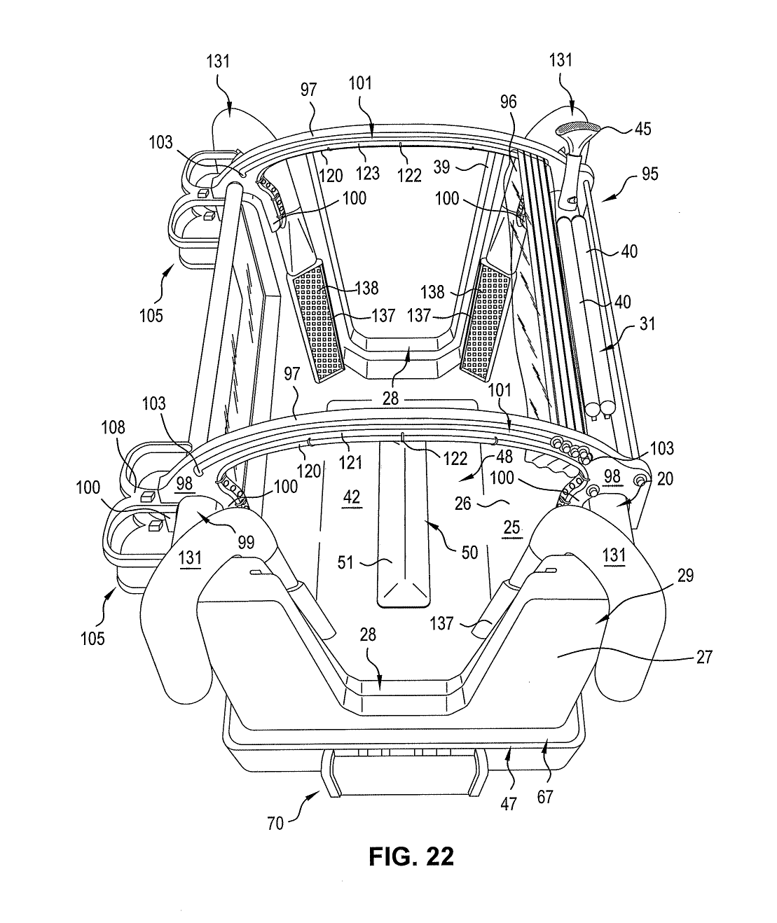

Referring to FIG. 22, the ends of the plows 101 of the truss arms 97 are preferably provided with notched recesses 103 forming a detent for receiving the endmost rods 102 of the hood 96. Such detents are preferred to provide a locking system for engaging the rods 102 forming the outer edges of the hood 96, to secure the ends of the hood 96 in position. Other detents can similarly be provided to hold the hood 96 in desired intermediate positions. The rods 102 are preferably sized to freely move in either direction within the plows 101, which operate as guiding tracks for the hood 96. The recesses 103 can retain the endmost rods 102 in position to help facilitate deployment of the hood 96. When the hood 96 is not being used, the rods 102 can be neatly stacked at either end of the plows 101, conveniently folding the flexible sheet as a result.

The resulting hood assembly 95 is versatile and easy to use. The hood 96 helps prevent spraying and splashing of water and chemicals. Providing a transparent hood 96 allows the user to clearly view the animal during all phases of the washing and dipping to be performed, and also helps to calm the animal by allowing the animal to see through the enclosure 20. The hood 96 is easily operated, making the hood 96 easy to open and close, and allowing the hood 96 to be deployed rapidly, which can be particularly useful should the animal begin to shake during the washing process. The hood 96 is also easily retracted, either to the rear or to the front of the enclosure 20, occupying minimal space or usable area within the shell 25.

One or more of the mounting brackets 98 can include a hook 104, such as the “J” hooks illustrated in the drawings, for receiving and supporting desired implements. This can include towels, dispensers and other implements used for the washing or dipping process to take place. This can also include holders, such as the holder 105, for organizing received implements. The hooks 104 can be paired and, if desired, vertically stacked for added support. The hooks 104 can be separate structures attached to the brackets 98, or can be integrally formed as part of the brackets 98.

The holders 105 can be used to receive any of a variety of implements, such as bottles, cartons, brushes, towels, and other useful implements. In the embodiment shown, each holder 105 includes an upper plate 106 and a lower plate 107. The upper plate 106 has a mounting bracket 108 including a slot 109 for engaging one of the hooks 104, to support the plate 106, and a slot 110 for engaging the bracket 98, to stabilize the plate 106. Two U-shaped brackets 111 extend from each mounting bracket 108, for use in holding desired implements. Other numbers of brackets 111 can be associated with the mounting bracket 108, if desired. The mounting bracket 108 for the lower plate 107 is similarly configured, replacing the open brackets 111 with closed bases 112, and can also include a raised peripheral rim, if desired. As an alternative to the use of separate upper and lower plates, the holder 105 can also be formed as a unitary structure. The structural features of the holders 105 can be freely varied in shape, size and contour, as desired.

As a further alternative, and referring to FIG. 21, a storage shelf 180 can be provided to receive various implements such as bottles, cartons, brushes, towels, and other useful implements, alone or in combination with the holders 105. In the embodiment shown, the storage shelf 180 is rectangular in overall shape and is centered horizontally within the extension area 44 on the side 30 which forms the front of the enclosure 20. To maximize available space, the depth of the storage shelf 180 is slightly smaller than the distance between the inner and outer walls of the shell 25. A retaining bar 181 is located along lower regions of the storage shelf 180, about one-third of the way up from the bottom 182, and extends horizontally across outer portions of the storage shelf. As an example, the retaining bar 181 can be formed of a ⅜″ round, fiberglass dowel rod. The structural features of the storage shelf 180 can also be freely varied in shape, size and contour, as desired.

The illustrated storage shelf 180 is manufactured separately and installed into a cavity that can be cut or molded into the outer, lower-most portions of the side 30. The storage shelf 180 has an overlapping perimeter flange 183 including a series of holes which are evenly spaced and centered within the flange 183. The series of holes in the perimeter flange 183 can receive suitable hardware 184 for retaining purposes, such as plastic, push-in type “Christmas Tree” fasteners, screws or other suitable fasteners. As further alternatives, the storage shelf 180 can be molded as part of the side 30, and one or more storage shelves 180 can be provided at various locations other than the forward location illustrated.

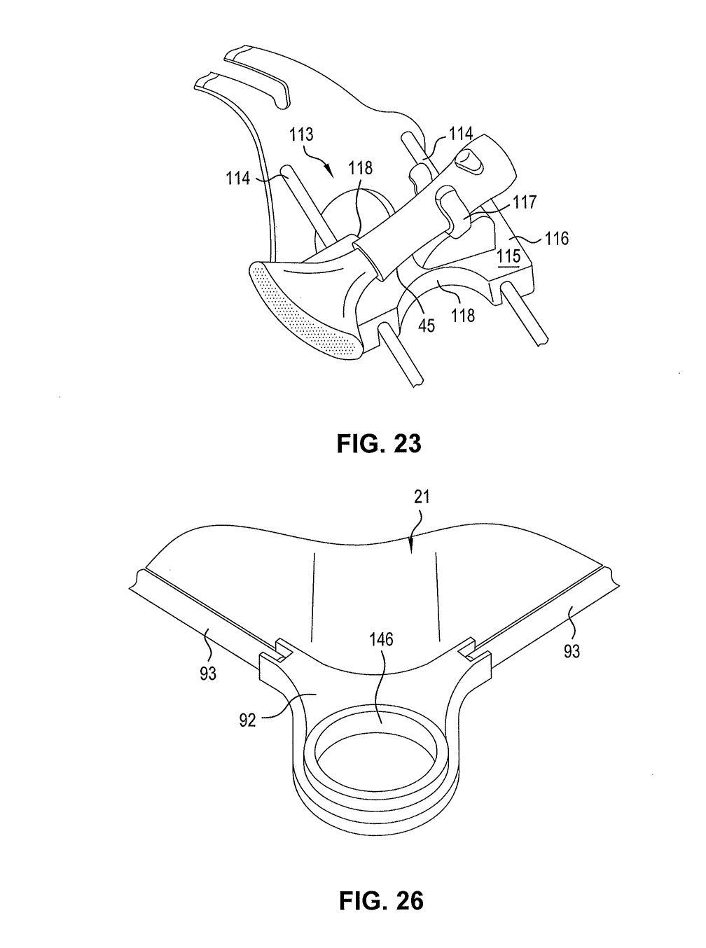

As is best seen in FIG. 1, the hood assembly 95, preferably to the rear, farthest from the user, can include an assembly 113 for receiving and supporting one of the spray heads 45. Referring to FIG. 23, the assembly 113 includes a pair of rods 114 attached to and extending between the truss arms 97, preferably just above the mounting brackets 98, and form a track for receiving a carriage 115. The bottom side of the carriage 115 includes two inverted, U-shaped plows with the same spacing as the rods 114. The two plows are preferably slightly wider than the rods 114 to facilitate sliding along the track. The surface 116 of the carriage 115 is preferably set at a downward angle of about 15°, to direct a supported shower head 45 toward the center of the enclosure 20. A faucet clamp 117 is preferably mounted to the surface 116 to receive the spray head 45 and hold the spray head 45 in position on the carriage 115. The faucet clamp 117 is preferably pivotally mounted to the carriage 115, allowing the spray head 45 to rotate on the surface 116 of the carriage 115. Rotation of the faucet clamp 117 can be limited, if desired. For example, a slot can be formed in the surface 116 of the carriage 115 to receive the base of the faucet clamp 117, so that contact between the slot and the clamp limits rotation of the spray head 45 received by the faucet clamp 117. Restriction of the rotation of the spray head to 20°, in either direction, is presently considered to be preferable for complete coverage of the stall. The sides of the carriage 115 each preferably include a cut-out 118 to accommodate the two faucet heads 45 when resting in their upright, storage positions.

The carriage 115, and the spray head 45 received by the carriage 115, is capable of full lateral movement along the track and between the two arched truss arms 97, providing the user with a self-supporting, directional, water source within the enclosure 20.

The system 1 preferably incorporates lighting for the illumination of the interior of the enclosure 20 and to assist with ingress and egress. Such lighting can advantageously be incorporated into the hood assembly 95 to position the lighting over the wash area and the door openings 28. In the embodiment illustrated, such illumination is performed with strip lighting, such as Cool White Model No. SMD5050, 120 v High Power, flexible, flat, LCD lighting strips manufactured by CBconcept Corp. of San Francisco, Calif. The strip lighting can be placed within a waterproof, translucent film or flexible plastic casing, if desired, to help prevent the lighting from getting wet.

Referring to FIG. 22, such lighting strips 120 are advantageously mounted to the truss arms 97, preferably along the bottoms of the truss arms. A protected mounting for the lighting strips 120 can be obtained by placing the lighting strips 120 in a channel developed along the bottom edges of the truss arms 97. For example, the undersides of the truss arms 97 can be provided with an extended edge 121, and a series of hooks 122 can be used to develop L-shaped brackets for holding the lighting strips 120 within a channel formed by the extended edge 121. The lighting strips 120 can then be secured within the developed channels, for example, by using L-shaped clips 123 for enclosing the channels.

Each strip light 120 preferably extends along the inner legs 100 of the mounting brackets 98 positioned toward the front of the enclosure 20, along the truss arms 97, and down portions of the inner legs 100 of the mounting brackets 98 positioned to the rear of the enclosure 20. Each of the lighting strips 120 then preferably extends upwardly and over the rear rim of the enclosure 20 to allow water on the lighting strips 120 to drip into the shell 25. The resulting strip lighting is preferably recessed within a groove for protecting the lighting strips from moving parts and implements being used within the enclosure 20 and along the top rim 99 of the shell 25.

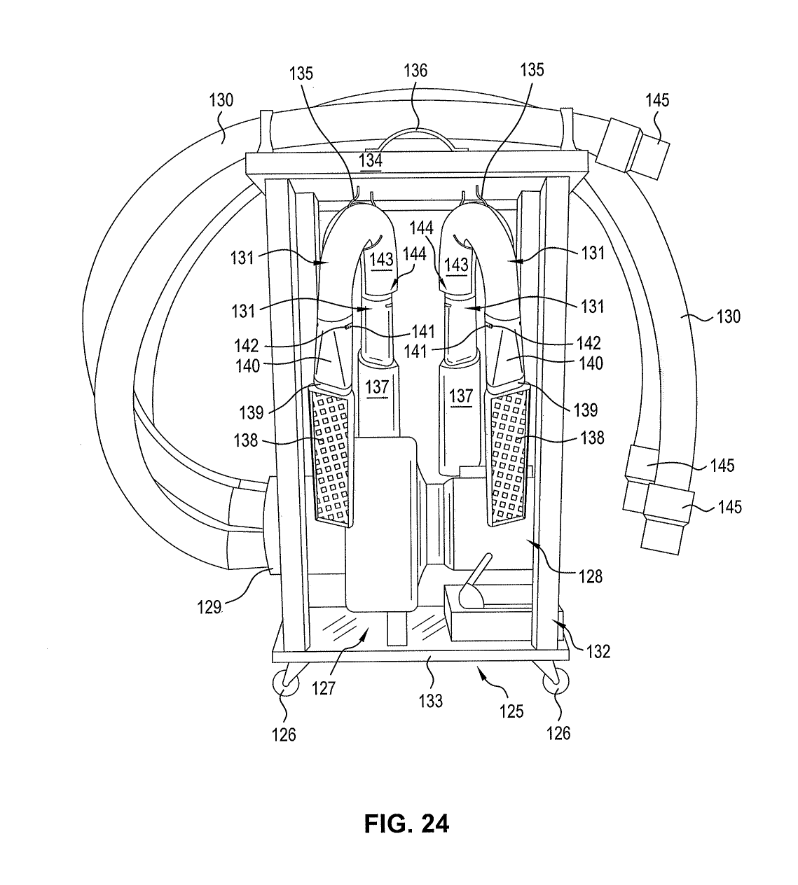

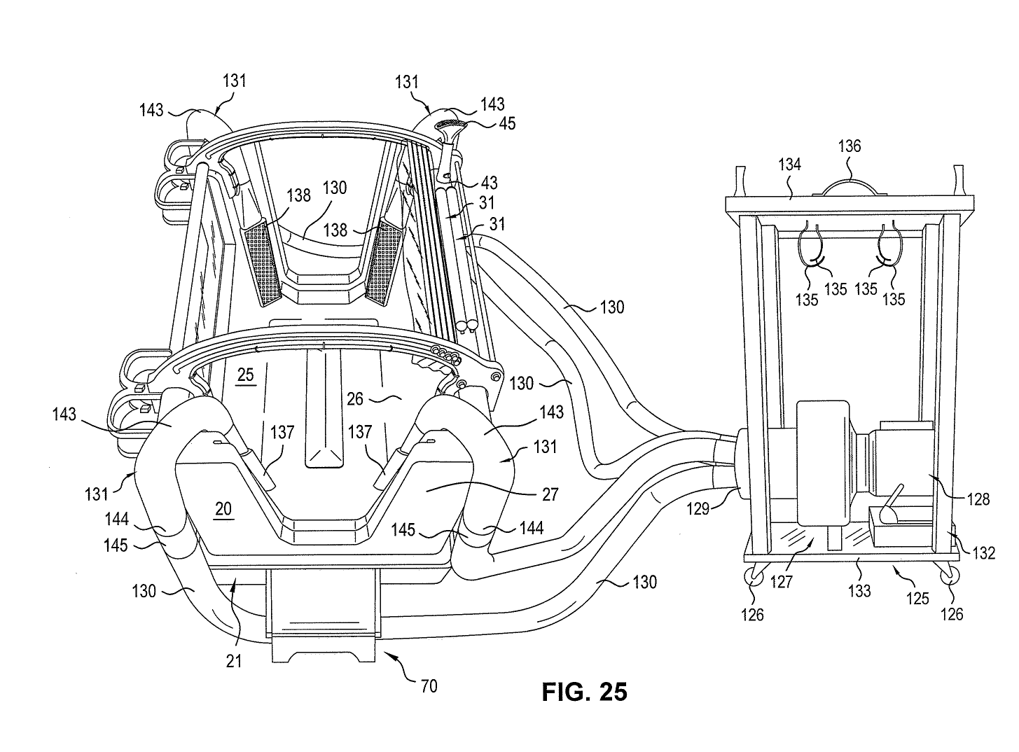

FIG. 24 shows an air circulation unit 125 that can be combined with the system 1 to deliver air for drying an animal in the enclosure 20, and also for ventilation of the enclosure 20, if desired. Use of the air circulation unit 125 is optional, although preferable for most applications to facilitate drying and to provide ventilation, particularly when using chemicals associated with dipping, or some other treatment. The unit 125 is preferably made portable, and is preferably able to roll on casters 126 for ease of use. The unit 125 is easily and quickly assembled for use, and stored following use. FIG. 25 shows an assembly of the air circulation unit 125 and the unit 10.

The illustrated air circulation unit 125 includes a blower 127 which is preferably combined with a heating unit 128. The outlet of the blower 127 includes a manifold 129 capable of delivering circulated air to a series of conduits, for example, conventional 2″ vacuum hoses 130. A series of air vents 131 are connectable to the hoses 130, for communicating with the blower 127 and with the enclosure 20. To promote ease of use, these components are preferably received by a carrier, such as the illustrated cart 132. The blower 127 and the heating unit 128 are preferably mounted to the cart 132, for example, over the base 133. The hoses 130 and vents 131 can be draped over upper portions 134 of the cart 132, or a series of hooks 135 or other supporting structures can be used to receive these components, as desired. Clamps, such as the C-clamps located along the top 134 of the cart 132 shown in FIG. 24, can be provided to cooperate with exterior contours of the hoses 130 to secure the hoses in place. The base 133 preferably receives the casters 126, and a handle 136 is advantageously provided to facilitate movements of the cart 132. The handle is advantageously located at the top 134 of the cart 132 to allow the air circulation unit 125 to be carried.

Any of a variety of different types of fans, in any of a variety of configurations for the circulation of air, can be used as the blower 127. The use of a Model M-6 SCP, 530 CFM blower, manufactured by Tjernlund Products, Inc., of White Bear Lake, Minn., is presently considered preferred. The blower 127 can receive heated air from any of a variety of different types of heaters. The heating unit 128 can be implemented with heating elements incorporated into the blower 127 or by using a separate, stand-alone heating unit, preferably with adjustable heat settings. The use of a ceramic utility heater, such as the Model No. DQ1016A, Soleil, 1500 watt heater manufactured by Everstar Enterprises Corporation of Shenzhen, China, and sold by The Home Depot, Inc., of Atlanta, Ga. (Model No. 307-533) is presently considered preferred. The blower 127 and the heating unit 128 can be hard-wired, or plugged into a switched outlet 23 associated with the unit 10. The fan speed of the blower 127 is preferably made adjustable using, for example, a rheostat or some other variable electrical device suitably located on the heating unit 128 or on the unit 10, to control the amount of air flow being produced, or the fan speed can be fixed, if desired. The heating unit 128 can be fixed in position or removably mounted adjacent to the air intake of the blower 127. Removably mounting the heating unit 128 adjacent to the air intake of the blower 127 allows the heating unit 128 to be removed, for example, to convert a warm-air system to an exhaust system, as will discussed more fully below.

A series of four vents 131 are preferably used, one for each of the four corners of the enclosure 20. Each vent 131 has a shell 137, which forms a plenum, and a screen 138 enclosing the front of the shell 137. The screen 138 is preferably removable from the shell 137, for cleaning, and also preferably includes a series of apertures, on the order of ⅛″, to optimize air flow through the screen 138 by maximizing air flow while maintaining the animal's comfort. The shell 137 is also preferably provided with one or more deflection surfaces to further optimize air flow through each vent 131. A series of three deflection surfaces that become progressively wider as they pass into the shell 137 from the inlet 139, and that are evenly spaced along the shell 137 between the top, middle and bottom, each having a flared or curved, outwardly directed surface, is presently considered preferred to help direct air moving through the vents 131.

The inlet 139 of each shell 137 preferably receives an extension 140, which preferably includes two, opposing slots 141 for engaging pins 142 associated with a drop pipe 143. The drop pipe 143 is preferably round conduit forming an inverted U-shape for engaging the top rim 99 of the shell 25 of the enclosure 20. The pins 142 are engaged in the slots 141 to secure the drop pipe 143 to the extension 140. The slots 141 are preferably elongated so that, following engagement, the pins 142 can slide within the slots 141, permitting lateral movements of the shell 137 so the vents 131 can be directionally adjusted side-to-side within the enclosure 20, in either direction, for example, by 45° from either wall.

The rear contours of each shell 137 preferably have a shape similar to, and complementary to the interior walls of the shell 25. This helps minimize the amount of space each vent 131 occupies within the shell 25 along the inside, vertical corners, which is presently considered to be the most efficient location for the vents 131. Portions of the inverted, U-shaped drop pipe 143, for example, the end portions for engaging the extensions 140, preferably have a slightly oblong portion, with a slightly longer diameter perpendicular to the open face of each vent 131, to provide a clearance for the pins 142 of the drop pipe 143 to engage the slots 141 of the extension 140. Upper portions of the shell 25, along the rim or the walls, can be provided with shaped recesses 147 for receiving contoured surfaces of the drop pipes 143, if desired, so that when the vents 131 are set in place, portions of the outer surfaces of the drop pipes 143 can engage the shaped recesses 147 and retain the vents 131 in proper position, for example, the preferred 45° position previously described.

The drop pipes 143 connect to the extensions 140 and continue up the inside corners of the shell 25, over the top rim 99 and down the exterior walls of the shell 25, so the inverted U-shape engages the tapered contours of the shell 25. The assembled vents 131 can be left in position over the rim 99 of the shell 25 because of their minimal space requirements and their self-draining, waterproof construction. The lengths of the drop pipes 143 inside the enclosure 20 can be extended, for example, to accommodate shorter breeds of animals within units 10 that can also accommodate larger breeds of animals, by increasing the lengths of the drop pipes 143 or using additional extension tubes, or by increasing the lengths of the extensions 140 or the lengths of the shells 137 and screens 138, to locate the outlets of the vents 131 lower within the shell 25.

The open ends 144 of the drop pipes 143 each receive one of the hoses 130, and are preferably flared to more easily receive the ends 145 of the hoses 130. The hoses 130 can then neatly extend down the sides of the enclosure 20, for connection to the manifold 129 used to distribute air, or heated air, from the blower 127. In the embodiment shown, the manifold 129 has four connections that are slightly angled outwardly for easier connection of the hoses 130.

For systems 1 with an elevated unit 10, the hoses 130 can pass down the sides of the enclosure 20, through a series of openings 146 provided in the unit 10, preferably at corners of the enclosure 20, and beneath the unit 10, for attachment to the manifold 129 of the air circulation unit 125. For example, as shown in FIG. 14, the openings 146 can pass through extended portions of the platform 85, between the unit 10 and the rim 88. As an alternative, and referring to FIGS. 15 and 26, the openings 146 can be formed as part of the corner pieces 92 attached to the rim 72 of the base 21. The air circulation unit 125 can then be located adjacent to the unit 10, as is shown in FIG. 25, or beneath the elevated unit 10, if preferred.

Some flea and tick dipping solutions can use harsh chemicals to kill the insects and, as a result, strong odors can often be present when these formulations are used. Odors such as these can be effectively vented to an exterior space by using the enclosure 20 as a confined space for containing the odors, and by reconfiguring the air circulation unit 125 to vent the enclosure 20 to a suitable exterior space so both the animal and a user are not overwhelmed by such odors. The air circulation unit 125 can be reconfigured to vent the enclosure 20 by removing the heating unit 128 from the inlet of the blower 127 and by then connecting an air duct, such as a flexible conduit, between the inlet of the blower 127 and the exterior space to which odors are to be vented, for example, to an exterior wall vent. The direction of the fan motor associated with the blower 127 is then reversed, for example, using a reverse polarity switch, to transform the blower 127 into an exhaust fan. The vents 131 can then be used as intake vents for drawing fumes from the enclosure 20, for discharge outdoors.

The previously described vents 131 take the form of separate structures which can be removably mated with the shell 25 of the enclosure 20. As an alternative to the use of separate structures, vents can be incorporated into the shell 25 of the enclosure 20. For example, a hollow shell 25 can be used as a plenum for communicating with the air circulation unit 125 and a series of vents can be formed in the inner walls 26 of the shell 25. Such vents can be made waterproof, or waterproof covers can be mounted over the vents, if desired, to help prevent fluids from entering the interior of the shell 25.

It will be understood that while the present invention has been described based on specific embodiments incorporating specified parts, the present invention further encompasses all enabled equivalents of the parts described, and that various changes in the details, materials and arrangement of parts which have been herein described and illustrated in order to explain the nature of this invention may be made by those skilled in the art within the principle and scope of the invention as expressed in the following claims.

In particular, the foregoing description discusses various dimensions, materials, and alternative structures. It will be understood that the dimensions and materials are merely illustrative, and can be varied to suit a particular application or environment, and that the various alternative structures can be combined and interchanged as needed, or as is appropriate to suit a particular application or environment. For example, to meet the needs of the potentially wide scope of animal sizes to be accommodated, the foregoing apparatus can be implemented as a complete line of portable stalls having different sizes so the animal fits correctly and so the apparatus can occupy a minimum amount of space, or the apparatus can be implemented as a fixed or permanent unit of a single size. The size and configuration of the platform 85 and the alternative base configuration shown in FIG. 15 can similarly be varied. Other variations will be apparent to those skilled in the art.

1. A system for washing, dipping, and drying animals, comprising:
an enclosure for receiving the animal, wherein the enclosure includes a drain for discharging fluids received in the enclosure;
a water supply connection coupled with a first spray head for directing supplied water into the enclosure;
a single drainage control valve located within the enclosure;
a pump fluidly coupling the drain of the enclosure with an inlet of the drainage control valve for actively drawing fluids from the drain to the drainage control valve;
a drainage system fluidly coupled with a first outlet of the drainage control valve and directly coupled with an external drain; and
a second spray head fluidly coupled with a second outlet of the drainage control valve for recycling fluids from the drain of the enclosure;
wherein the drainage control valve is selectively actuated between at least a first mode of operation, for selectively actively discharging the fluids from the drain of the enclosure and through the drainage system, and a second mode of operation, for actively recycling the fluids back into the enclosure from the drain of the enclosure and through the second spray head.

2. The system of claim 1 wherein the enclosure is a substantially water-tight, fume-exhausting showering stall.

3. The system of claim 1 wherein the enclosure is movable.

4. The system of claim 1 wherein the enclosure includes an upper, double-walled shell coupled with a lower base unit housing utilities associated with the shell.

5. The system of claim 1 wherein the water supply is directly coupled with plumbed features associated with a tub, sink or laundry connection.

6. The system of claim 1 wherein the water supply is coupled with a dispenser for adding a solution to the water.

7. The system of claim 1 wherein a supply of the recycled fluid is coupled with a dispenser for adding a solution to the recycled fluid.

8. The system of claim 1 which further includes a hood for covering the enclosure.

9. The system of claim 8 wherein the hood is retractable.

10. The system of claim 8 wherein the hood further includes lighting for illuminating the enclosure.

11. The system of claim 8 wherein the hood further includes a carriage supporting a spray head for movement along the enclosure.

12. The system of claim 1 which further includes an air circulating unit coupled with the enclosure.

13. The system of claim 12 wherein the air circulating unit is a module separate from the enclosure, and wherein the module is movable.

14. The system of claim 12 wherein the air circulating unit includes a blower for moving air through a plurality of vents coupled with the enclosure, for delivery to the enclosure.

15. The system of claim 14 wherein the air circulating unit further includes a heating unit for heating the air moving through the vents.

16. The system of claim 12 wherein the air circulating unit includes a blower for drawing air from a plurality of vents coupled with the enclosure, for ventilating the enclosure.

17. The system of claim 12 wherein the air circulating unit includes a plurality of vents coupled with corners of the enclosure.

18. The system of claim 17 wherein the vents are located at each corner of the enclosure.

19. The system of claim 17 wherein the vents are directionally adjustable.

20. The system of claim 1 which further includes a support for elevating the enclosure.

21. The system of claim 20 wherein the support is foldably coupled with the enclosure.

22. The system of claim 20 wherein the support has an adjustable height.

23. The system of claim 20 which further includes a detachable staircase communicating with the elevated enclosure, for ingress and egress.

24. The system of claim 1 which further includes a retractable step communicating with the enclosure, for ingress and egress.

25. The system of claim 1 which further includes a retractable stool, for use by an operator of the system.

26. The system of claim 1 which further includes a tether for securing the animal.

27. The system of claim 1 which further includes at least one removable panel for enclosing portions of the enclosure.

28. The system of claim 27 wherein the panel is transparent.

29. The system of claim 27 wherein the panel encloses a door for entering or leaving the enclosure.

30. The system of claim 27 wherein the panel encloses a region for accessing interior portions of the enclosure.

31. The system of claim 27 wherein the enclosure further includes a slot for receiving and storing the panel.

32. The system of claim 1 which further includes at least one support for receiving ancillary implements.

33. The system of claim 32 wherein the support is a holder coupled with portions of the system.

34. The system of claim 32 wherein the support is a storage shelf provided in the enclosure.

35. The system of claim 1 which further includes a hose-line chase coupled with at least one spray head.

36. The system of claim 35 wherein the hose-line chase includes a riser and a guide retained in spaced relation to each other by upper and lower supports, for receiving a hose line.

37. The system of claim 36 which further includes an anti-kink ring coupled with the riser, for receiving the hose line.

38. The system of claim 36 which further includes a plurality of clamps coupled with the riser, for receiving portions of the hose line.

39. The system of claim 36 which further includes a plurality of guides for slidingly receiving portions of the hose line.

40. The system of claim 1 wherein the single drainage control valve is located within a lower base unit of the enclosure.

41. The system of claim 1, wherein the single drainage control valve is a sole control valve of the system.
